(19) United States
(12) Patent Application Publication
(10) Pub. No.: US 2025/0227704 A1
(43) Pub. Date: Jul. 10, 2025

(54) UPLINK CONTROL INFORMATION MULTIPLEXING ACROSS DIFFERENT TRANSMISSION RECEPTION POINTS

(71) Applicant: QUALCOMM Incorporated, San Diego, CA (US)

(72) Inventors: Shaozhen GUO, Beijing (CN); Mostafa KHOSHNEVISAN, San Diego, CA (US); Jing SUN, San Diego, CA (US); Xiaoxia ZHANG, San Diego, CA (US); Tao LUO, San Diego, CA (US); Peter GAAL, San Diego, CA (US); Yan ZHOU, San Diego, CA (US); Fang YUAN, Beijing (CN); Yi HUANG, San Diego, CA (US)

(21) Appl. No.: 18/852,622

(22) PCT Filed: Jun. 8, 2022
(86) PCT No.: PCT/CN2022/097598

§ 371 Date: Sep. 30, 2024

(51) Int. Cl. H04W 72/21; H04L 5/00; H04L 47/32

(52) U.S. Cl. CPC H04W 72/21; H04L 5/0053; H04L 47/323

(57) ABSTRACT

Systems and methods for uplink control information (UCI) multiplexing across multiple transmission and reception points (TRPs) in a wireless communication system are provided. A UE may receive UCI requests from different TRPs for overlapping PUCCH resources. The PUCCH resources may also overlap a PUSCH resource. The UE may be configured to multiplex the PUCCHs together and/or multiplex the PUCCHs on the PUSCH. UCIs for different TRPs of the same UCI type may be encoded, rate matched, and mapped jointly or separately. When multiplexing PUCCHs together, the resulting PUCCH resource may be determined based on a predetermined rule.

### TECHNICAL FIELD

This application relates to wireless communication devices, systems, and methods, and more particularly to devices, systems, and methods for uplink control information (UCI) multiplexing across different transmission and reception points (TRPs).

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BSs), each simultaneously supporting communications for multiple communication devices, which may be otherwise known as user equipment (UE).

To meet the growing demands for expanded mobile broadband connectivity, wireless communication technologies are advancing from the long term evolution (LTE) technology to a next generation new radio (NR) technology, which may be referred to as 5^{th} Generation (5G), designed to provide a lower latency, a higher bandwidth or a higher throughput, and a higher reliability than LTE. UE devices may communicate with multiple network entities concurrently, for instance multiple TRPs. Existing methods for communication in some instances are not optimal for communication with multiple network units. Therefore, there exists a need for improved methods of communication across different network units.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

One aspect of the present disclosure includes a method of wireless communication performed by a user equipment (UE), the method comprising determining that a first physical uplink control channel (PUCCH) resource including a first set of uplink control informations (UCIs) associated with a first control resource set (CORESET) pool index value overlaps in a time domain with a second PUCCH resource including a second set of UCIs associated with a second CORESET pool index value. The method further comprises receiving a scheduling configuration for a physical uplink shared channel (PUSCH) overlapping in time with at least one of the first PUCCH or the second PUCCH. The method further comprises multiplexing the first and second sets of UCIs on the PUSCH.

Another aspect of the present disclosure includes a method of wireless communication performed by a user equipment (UE), the method comprises determining that a first physical uplink control channel (PUCCH) resource including a first set of uplink control informations (UCIs) associated with a first control resource set (CORESET) pool index value overlaps in a time domain with a second PUCCH resource including a second set of UCIs associated with a second CORESET pool index value, wherein the first PUCCH resource is determined based on a PUCCH resource indicator (PRI) field in a first DCI, and the second PUCCH resource is determined based on a PRI field in a second DCI. The method further comprises selecting a PUCCH resource set from a PUCCH resource pool based on a total number of bits in the first set of UCIs and the second set of UCIs. The method further comprises selecting a PUCCH resource associated with the selected PUCCH resource set based on a predetermined rule. The method further comprises multiplexing the first set of UCIs and the second set of UCIs on the selected PUCCH resource.

Another aspect of the present disclosure includes a user equipment (UE) comprising a processor configured to determine, that a first physical uplink control channel (PUCCH) resource including a first set of uplink control informations (UCIs) associated with a first control resource set (CORESET) pool index value overlaps in a time domain with a second PUCCH resource including a second set of UCIs associated with a second CORESET pool index value. The UE further comprises a transceiver configured to receive a scheduling configuration for a physical uplink shared channel (PUSCH) overlapping in time with at least one of the first PUCCH or the second PUCCH. The transceiver is further configured to multiplex the first and second sets of UCIs on the PUSCH.

Another aspect of the present disclosure includes a user equipment (UE), comprising a processor configured to determine that a first physical uplink control channel (PUCCH) resource including a first set of uplink control informations (UCIs) associated with a first control resource set (CORESET) pool index value overlaps in a time domain with a second PUCCH resource including a second set of UCIs associated with a second CORESET pool index value, wherein the first PUCCH resource is determined based on a PUCCH resource indicator (PRI) field in a first DCI, and the second PUCCH resource is determined based on a PRI field in a second DCI. The processor is further configured to select a PUCCH resource set from a PUCCH resource pool based on a total number of bits in the first set of UCIs and the second set of UCIs. The processor is further configured to select a PUCCH resource associated with the selected PUCCH resource set based on a predetermined rule. The UE further comprises a transceiver configured to multiplex the first set of UCIs and the second set of UCIs on the selected PUCCH resource.

Another aspect of the present disclosure includes a user equipment (UE), comprising means for determining that a first physical uplink control channel (PUCCH) resource including a first set of uplink control informations (UCIs) associated with a first control resource set (CORESET) pool index value overlaps in a time domain with a second PUCCH resource including a second set of UCIs associated with a second CORESET pool index value. The UE further comprises means for receiving a scheduling configuration for a physical uplink shared channel (PUSCH) overlapping in time with at least one of the first PUCCH or the second PUCCH. The UE further comprises means for multiplexing the first and second sets of UCIs on the PUSCH.

Other aspects, features, and embodiments will become apparent to those of ordinary skill in the art, upon reviewing the following description of specific, exemplary aspects in conjunction with the accompanying figures. While features may be discussed relative to certain aspects and figures below, all aspects can include one or more of the advantageous features discussed herein. In other words, while one or more aspects may be discussed as having certain advantageous features, one or more of such features may also be used in accordance with the various aspects discussed herein. In similar fashion, while exemplary aspects may be discussed below as device, system, or method aspects it should be understood that such exemplary aspects can be implemented in various devices, systems, and methods.

### BRIEF DESCRIPTION OF THE DRAWINGS

FIG. 1 illustrates a wireless communication network according to some aspects of the present disclosure.

FIG. 2 illustrates an example portion of a wireless communications system that supports RU sharing techniques in wireless communications according to some aspects of the present disclosure.

FIG. 3 illustrates a diagram of a system including a device that supports RU sharing techniques in wireless communications according to some aspects of the present disclosure.

FIG. 4 illustrates an example wireless communication network according to some aspects of the present disclosure.

FIG. 5 illustrates an example resource diagram according to some aspects of the present disclosure.

FIG. 6 illustrates an example resource diagram according to some aspects of the present disclosure.

FIG. 7 illustrates an example process flow diagram according to some aspects of the present disclosure.

FIG. 8 illustrates an example process flow diagram according to some aspects of the present disclosure.

FIG. 9 illustrates an example process flow diagram according to some aspects of the present disclosure.

FIG. 10 is a signaling diagram according to some aspects of the present disclosure.

FIG. 11 illustrates a block diagram of a network unit according to some aspects of the present disclosure.

FIG. 12 illustrates a block diagram of a user equipment (UE) according to some aspects of the present disclosure.

FIG. 13 is a flow diagram of a wireless communication method performed by a user equipment (UE) according to some aspects of the present disclosure.

FIG. 14 is a flow diagram of a wireless communication method performed by a user equipment (UE) according to some aspects of the present disclosure.

FIG. 15 is a flow diagram of a wireless communication method performed by a network unit according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some aspects, well-known structures and components are shown in block diagram form in order to avoid obscuring such concepts.

This disclosure relates generally to wireless communications systems, also referred to as wireless communications networks. In various aspects, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, Global System for Mobile Communications (GSM) networks, 5^{th} Generation (5G) or new radio (NR) networks, as well as other communications networks. As described herein, the terms “networks” and “systems” may be used interchangeably.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the UMTS mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive Internet of things (IoTs) with an Ultra-high density (e.g., ˜1M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 ms), and users with wide ranges of mobility or lack thereof; and (3) with enhanced mobile broadband including extreme high capacity (e.g., ˜ 10 Tbps/km²), extreme data rates (e.g., multi-Gbps rate, 100+ Mbps user experienced rates), and deep awareness with advanced discovery and optimizations.

A 5G NR communication system may be implemented to use optimized OFDM-based waveforms with scalable numerology and transmission time interval (TTI); having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3GHz FDD/TDD implementations, subcarrier spacing may occur with 15 kHz, for example over 5, 10, 20 MHz, and the like bandwidth (BW). For other various outdoor and small cell coverage deployments of TDD greater than 3 GHZ, subcarrier spacing may occur with 30 kHz over 80/100 MHz BW. For other various indoor wideband implementations, using a TDD over the unlicensed portion of the 5 GHz band, the subcarrier spacing may occur with 60 kHz over a 160 MHz BW. Finally, for various deployments transmitting with mmWave components at a TDD of 28 GHz, subcarrier spacing may occur with 120 kHz over a 500 MHz BW. In certain aspects, frequency bands for 5G NR are separated into multiple different frequency ranges, a frequency range one (FR1), a frequency range two (FR2), and FR2x. FR1 bands include frequency bands at 7 GHz or lower (e.g., between about 410 MHz to about 7125 MHz). FR2 bands include frequency bands in mm Wave ranges between about 24.25 GHz and about 52.6 GHz. FR2x bands include frequency bands in mmWave ranges between about 52.6 GHz to about 71 GHz. The mm Wave bands may have a shorter range, but a higher bandwidth than the FR1 bands. Additionally, 5G NR may support different sets of subcarrier spacing for different frequency ranges.

The scalable numerology of the 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with UL/downlink scheduling information, data, and acknowledgement in the same subframe. The self-contained integrated subframe supports communications in unlicensed or contention-based shared spectrum, adaptive UL/downlink that may be flexibly configured on a per-cell basis to dynamically switch between UL and downlink to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may comprise at least one element of a claim.

The present disclosure describes systems and methods for UCI multiplexing across different TRPs. UEs may have the capability of communicating with multiple network units such as transmission reception points (TRPs) where each TRP may act as a point of wireless connection between a UE and another network unit such as a base station (BS). Methods of communication such as multiplexing physical uplink control channel (PUCCH) messages with uplink control information (UCI) may be extended to be used by a UE across multiple TRPs. When multiple PUCCH messages are scheduled at overlapping times, a UE may benefit from multiplexing the two PUCCH messages together and communicating the multiplexed PUCCH to a single TRP. Further, when one or more of two time-domain overlapping PUCCHs are overlapped with one or more PUSCHs, it may be beneficial to multiplex the PUCCHs on the PUSCH.

A PUCCH resource may be scheduled for a UE to transmit an uplink control information (UCI). UCIs may have a number of types, including hybrid automatic repeat request-acknowledge (HARQ-Ack), channel state information (CSI) part 1, CSI part 2, and scheduling request (SR). A UCI may be scheduled on a PUCCH resource by a downlink control information (DCI) message sent on PDCCH from a TRP.

A control resource set (CORESET) may indicate resources to the UE for receiving PDCCH messages (e.g., DCI). Each CORESET can be configured with a value of CORESET pool index (e.g., via parameters CORESETPoolIndex). For example CORESET IDs 1 and 2 may be associated with CORESET pool index 0, and CORESET IDs 3 and 4 may be associated with CORESET pool index 1. As such, a UE may identify which TRP is sending a message to the UE, as each CORESET pool index may be associated with a different TRP. Also associated with CORESET pool indexes are PUCCH resource pools. A PUCCH resource pool is comprised of a number of PUCCH resource sets, and a PUCCH resource set is comprised of a number of PUCCH resources. In some instances, a PUCCH resource set is determined based on the number of bits in the UCI to be transmitted on the resource. The PUCCH resource from the PUCCH resource set may be determined based on a PUCCH resource indicator (PRI) field in the DCI scheduling the PUCCH. When multiple PUCCHs are multiplexed, however, different rules may be defined for determining PUCCH resources pools, PUCCH resource sets, and PUCCH resources, as described further herein.

When multiple UCIs are scheduled for multiple TRPs, and one or more of the PUCCHs scheduled for the UCIs overlap with a PUSCH, the UCIs may be encoded, rate matched, and mapped to the PUSCH. In some aspects, UCIs of the same type and associated with different CORESET pool index values may be concatenated and then jointly encoded, rate matched, and mapped. In other aspects, UCIs, even those of the same type and associated with different CORESET pool index values, may be separately encoded, rate matched, and mapped. In yet further aspects, whether or not to concatenate same-type UCIs across different CORESET pool index may be based on a UE configuration such as a radio resource control (RRC) configuration. Depending on UE capability, there may be a limit on the number of separate encode/rate match/map chains that are available concurrently. As such, UCIs may be dropped if there are more UCIs and/or concatenated UCIs to encode, rate match, and map.

In determining which PUCCH resource to use when concatenating two or more overlapping PUCCHs together, a UE may use a number of different rules. When the PUCCH resource pools for each of the PUCCHs to be multiplexed are different, there may be a rule for determining the PUCCH resource pool. For example, the PUCCH resource pool may be determined based on a fixed CORESET pool index, or the PUCCH resource pool may be configured (e.g., via RRC). The PUCCH resource set may be selected from the PUCCH resource pool based on the total number of bits in all the UCIs associated with the two overlapping PUCCHs. The PUCCH resource from the PUCCH resource set may be determined based on the PRI field of the last DCI associated with the same CORESET pool index value as the determined PUCCH resource pool.

If the PUCCH resource pools for each of the two overlapping PUCCHs to be multiplexed are the same, then the UE may use that PUCCH resource pool. The PUCCH resource set may be selected from the PUCCH resource pool based on the total number of bits in all the UCIs associated with the two overlapping PUCCHs. The PUCCH resource from the PUCCH resource set may be determined based on a predetermined rule. One rule may be to select a PUCCH resource based on the PRI field in the last DCI associated with a fixed CORESET pool index value (e.g., value 1) among the last DCI indicating the first PUCCH and the last DCI indicating the second PUCCH. Another rule may be to determine the PUCCH resource based on the PRI field in the last DCI indicating the lowest (or alternatively, the highest) PRI codepoint value among the last DCI indicating the first PUCCH and the last DCI indicating the second PUCCH.

Another rule may be to determine the PUCCH resource based on the PRI field in the last DCI among the first and second sets of DCIs (associated with both the first and second PUCCH). However, in some instances, the last DCI indicating the first PUCCH and the last DCI indicating the second PUCCH may be received in the same PDCCH monitoring occasion. When this occurs, there may be a fallback rule for determining between the two last DCIs whose PRI value is to be used for determining the PUCCH resource. The fallback rule may be one based on, for example, a fixed CORESET pool index value, the highest/lowest PRI codepoint value, the highest/lowest CORESET ID, or the highest/lowest starting CCE index of the last DCIs respectively associated with each of the two overlapping PUCCHs.

Systems and methods described herein provide many advantages. By multiplexing PUCCHs onto PUSCH, a limitation against simultaneous PUCCH and PUSCH transmission may be subverted, allowing for more efficient communication. Multiplexing PUCCHs together may allow for simultaneous transmission of the UCIs scheduled for those PUCCHs together in a single PUCCH resource. The efficiencies may decrease power consumption by the UE, and more efficiently use network resources. Further, by reusing existing encoding/rate matching/mapping chains for different UCI types, existing UE hardware may be efficiently adapted for use in the scenarios described herein.

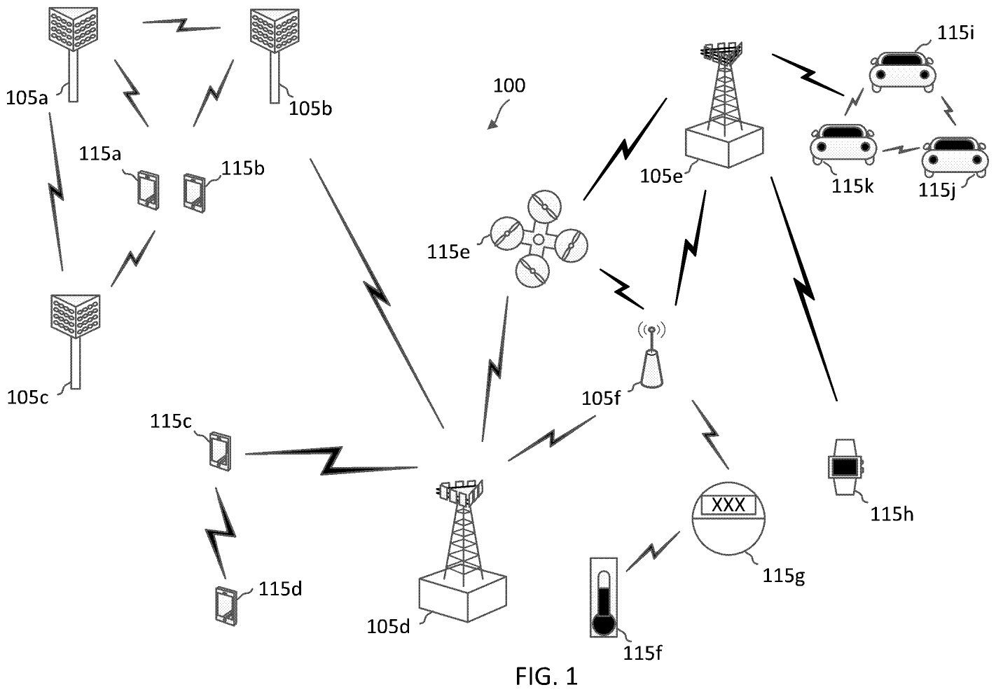

FIG. 1 illustrates a wireless communication network 100 according to some aspects of the present disclosure. The network 100 may be a 5G network. The network 100 includes a number of base stations (BSs) 105 (individually labeled as 105a, 105b, 105c, 105d, 105e, and 105f) and other network entities. A BS 105 may be a station that communicates with UEs 115 (individually labeled as 115a, 115b, 115c, 115d, 115e, 115f, 115g, 115h, and 115k) and may also be referred to as an evolved node B (eNB), a next generation eNB (gNB), an access point, and the like. Each BS 105 may provide communication coverage for a particular geographic area. In 3GPP, the term “cell” can refer to this particular geographic coverage area of a BS 105 and/or a BS subsystem serving the coverage area, depending on the context in which the term is used.

A BS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In the example shown in FIG. 1, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. A BS 105 may support one or multiple (e.g., two, three, four, and the like) cells.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are examples of mobile smart phone-type devices accessing network 100. A UE 115 may also be a machine specifically configured for connected communication, including machine type communication (MTC), enhanced MTC (eMTC), narrowband IoT (NB-IoT) and the like. The UEs 115e-115h are examples of various machines configured for communication that access the network 100. The UEs 115i-115k are examples of vehicles equipped with wireless communication devices configured for communication that access the network 100. A UE 115 may be able to communicate with any type of the BSs, whether macro BS, small cell, or the like. In FIG. 1, a lightning bolt (e.g., communication links) indicates wireless transmissions between a UE 115 and a serving BS 105, which is a BS designated to serve the UE 115 on the downlink (DL) and/or uplink (UL), desired transmission between BSs 105, backhaul transmissions between BSs, or sidelink transmissions between UEs 115.

In operation, the BSs 105a-105c may serve the UEs 115a and 115b using 3D beamforming and coordinated spatial techniques, such as coordinated multipoint (CoMP) or multi-connectivity. The macro BS 105d may perform backhaul communications with the BSs 105a-105c, as well as small cell, the BS 105f. The macro BS 105d may also transmits multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an example of a gNB or an access node controller (ANC)) may interface with the core network through backhaul links (e.g., NG-C, NG-U, etc.) and may perform radio configuration and scheduling for communication with the UEs 115. In various examples, the BSs 105 may communicate, either directly or indirectly (e.g., through core network), with each other over backhaul links (e.g., X1, X2, etc.), which may be wired or wireless communication links.

The network 100 may also support mission critical communications with ultra-reliable and redundant links for mission critical devices, such as the UE 115e, which may be a drone. Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105e, or in multi-action-size configurations by communicating with another user device which relays its information to the network, such as the UE 115f communicating temperature measurement information to the smart meter, the UE 115g, which is then reported to the network through the small cell BS 105f. The network 100 may also provide additional network efficiency through dynamic, low-latency TDD/FDD communications, such as V2V, V2X, C-V2X communications between a UE 115i, 115j, or 115k and other UEs 115, and/or vehicle-to-infrastructure (V2I) communications between a UE 115i, 115j, or 115k and a BS 105.

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some aspects, the subcarrier spacing between adjacent subcarriers may be fixed, and the total number of subcarriers (K) may be dependent on the system BW. The system BW may also be partitioned into subbands. In other aspects, the subcarrier spacing and/or the duration of TTIs may be scalable.

In some aspects, the BSs 105 can assign or schedule transmission resources (e.g., in the form of time-frequency resource blocks (RB)) for downlink (DL) and uplink (UL) transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes or slots, for example, about 10. Each slot may be further divided into mini-slots. In a FDD mode, simultaneous UL and DL transmissions may occur in different frequency bands. For example, each subframe includes an UL subframe in an UL frequency band and a DL subframe in a DL frequency band. In a TDD mode, UL and DL transmissions occur at different time periods using the same frequency band. For example, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For example, each DL or UL subframe may have pre-defined regions for transmissions of reference signals, control information, and data. Reference signals are predetermined signals that facilitate the communications between the BSs 105 and the UEs 115. For example, a reference signal can have a particular pilot pattern or structure, where pilot tones may span across an operational BW or frequency band, each positioned at a pre-defined time and a pre-defined frequency. For example, a BS 105 may transmit cell specific reference signals (CRSs) and/or channel state information-reference signals (CSI-RSs) to enable a UE 115 to estimate a DL channel. Similarly, a UE 115 may transmit sounding reference signals (SRSs) to enable a BS 105 to estimate an UL channel. Control information may include resource assignments and protocol controls. Data may include protocol data and/or operational data. In some aspects, the BSs 105 and the UEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. an UL-centric subframe may include a longer duration for UL communication than for UL communication.

In some aspects, the network 100 may be an NR network deployed over a licensed spectrum. The BSs 105 can transmit synchronization signals (e.g., including a primary synchronization signal (PSS) and a secondary synchronization signal (SSS)) in the network 100 to facilitate synchronization. The BSs 105 can broadcast system information associated with the network 100 (e.g., including a master information block (MIB), remaining system information (RMSI), and other system information (OSI)) to facilitate initial network access. In some aspects, the BSs 105 may broadcast the PSS, the SSS, and/or the MIB in the form of synchronization signal block (SSBs) and may broadcast the RMSI and/or the OSI over a physical downlink shared channel (PDSCH). The MIB may be transmitted over a physical broadcast channel (PBCH).

In some aspects, a UE 115 attempting to access the network 100 may perform an initial cell search by detecting a PSS from a BS 105. The PSS may enable synchronization of period timing and may indicate a physical layer identity value. The UE 115 may then receive a SSS. The SSS may enable radio frame synchronization, and may provide a cell identity value, which may be combined with the physical layer identity value to identify the cell. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI and/or OSI. After decoding the MIB, the UE 115 may receive RMSI and/or OSI. The RMSI and/or OSI may include radio resource control (RRC) information related to random access channel (RACH) procedures, paging, control resource set (CORESET) for physical downlink control channel (PDCCH) monitoring, physical UL control channel (PUCCH), physical UL shared channel (PUSCH), power control, and SRS.

After obtaining the MIB, the RMSI and/or the OSI, the UE 115 can perform a random access procedure to establish a connection with the BS 105. In some examples, the random access procedure may be a four-step random access procedure. For example, the UE 115 may transmit a random access preamble and the BS 105 may respond with a random access response. The random access response (RAR) may include a detected random access preamble identifier (ID) corresponding to the random access preamble, timing advance (TA) information, an UL grant, a temporary cell-radio network temporary identifier (C-RNTI), and/or a backoff indicator. Upon receiving the random access response, the UE 115 may transmit a connection request to the BS 105 and the BS 105 may respond with a connection response. The connection response may indicate a contention resolution. In some examples, the random access preamble, the RAR, the connection request, and the connection response can be referred to as message 1 (MSG1), message 2 (MSG2), message 3 (MSG3), and message 4 (MSG4), respectively. In some examples, the random access procedure may be a two-step random access procedure, where the UE 115 may transmit a random access preamble and a connection request in a single transmission and the BS 105 may respond by transmitting a random access response and a connection response in a single transmission.

After establishing a connection, the UE 115 and the BS 105 can enter a normal operation stage, where operational data may be exchanged. For example, the BS 105 may schedule the UE 115 for UL and/or DL communications. The BS 105 may transmit UL and/or DL scheduling grants to the UE 115 via a PDCCH. The scheduling grants may be transmitted in the form of DL control information (DCI). The BS 105 may transmit a DL communication signal (e.g., carrying data) to the UE 115 via a PDSCH according to a DL scheduling grant. The UE 115 may transmit an UL communication signal to the BS 105 via a PUSCH and/or PUCCH according to an UL scheduling grant. The connection may be referred to as an RRC connection. When the UE 115 is actively exchanging data with the BS 105, the UE 115 is in an RRC connected state.

In an example, after establishing a connection with the BS 105, the UE 115 may initiate an initial network attachment procedure with the network 100. The BS 105 may coordinate with various network entities or fifth generation core (5GC) entities, such as an access and mobility function (AMF), a serving gateway (SGW), and/or a packet data network gateway (PGW), to complete the network attachment procedure. For example, the BS 105 may coordinate with the network entities in the 5GC to identify the UE, authenticate the UE, and/or authorize the UE for sending and/or receiving data in the network 100. In addition, the AMF may assign the UE with a group of tracking areas (TAs). Once the network attach procedure succeeds, a context is established for the UE 115 in the AMF. After a successful attach to the network, the UE 115 can move around the current TA. For tracking area update (TAU), the BS 105 may request the UE 115 to update the network 100 with the UE 115's location periodically. Alternatively, the UE 115 may only report the UE 115's location to the network 100 when entering a new TA. The TAU allows the network 100 to quickly locate the UE 115 and page the UE 115 upon receiving an incoming data packet or call for the UE 115.

UEs 115 may have the capability of communicating with multiple network units such as transmission reception points (TRPs) where each TRP may act as a point of wireless connection between a UE 115 and another network unit such as a BS 105. Methods of communication such as multiplexing PUCCH messages with UCI may be extended to be used by a UE 115 across multiple TRPs. When multiple PUCCH messages are scheduled at overlapping times, a UE 115 may benefit from multiplexing the two PUCCH messages together and communicating the multiplexed PUCCH to a single TRP. Further, when one or more of two time-domain overlapping PUCCHs are overlapped with one or more PUSCHs, it may be beneficial to multiplex the PUCCHs on the PUSCH.

A PUCCH resource may be scheduled for a UE 115 to transmit a UCI. UCIs may have a number of types, including HARQ-Ack, CSI part 1, CSI part 2, and SR. A UCI may be scheduled on a PUCCH resource by a DCI message sent on PDCCH from a TRP.

A control resource set (CORESET) may indicate resources to the UE 115 for receiving PDCCH messages (e.g., DCI). Each CORESET can be configured with a value of CORESET pool index (e.g., via parameters CORESETPoolIndex). For example CORESET IDs 1 and 2 may be associated with CORESET pool index 0, and CORESET IDs 3 and 4 may be associated with CORESET pool index 1. As such, a UE 115 may identify which TRP is sending a message to the UE 115, as each CORESET pool index may be associated with a different TRP. Also associated with CORESET pool indexes are PUCCH resource pools. A PUCCH resource pool is comprised of a number of PUCCH resource sets, and a PUCCH resource set is comprised of a number of PUCCH resources. In some instances, a PUCCH resource set is determined based on the number of bits in the UCI to be transmitted on the resource. The PUCCH resource from the PUCCH resource set may be determined based on a PUCCH resource indicator (PRI) field in the DCI scheduling the PUCCH. When multiple PUCCHs are multiplexed, however, different rules may be defined for determining PUCCH resources pools, PUCCH resource sets, and PUCCH resources, as described further herein.

When multiple UCIs are scheduled for multiple TRPs, and one or more of the PUCCHs scheduled for the UCIs overlap with a PUSCH, the UCIs may be encoded, rate matched, and mapped to the PUSCH. In some aspects, UCIs of the same type and associated with different CORESET pool index values may be concatenated and then jointly encoded, rate matched, and mapped. In other aspects, UCIs, even those of the same type and associated with different CORESET pool index values, may be separately encoded, rate matched, and mapped. In yet further aspects, whether or not to concatenate same-type UCIs across different CORESET pool index values may be based on a UE 115 configuration such as a radio resource control (RRC) configuration. Depending on UE 115 capability, there may be a limit on the number of separate encode/rate match/map chains that are available concurrently. As such, UCIs may be dropped if there are more UCIs and/or concatenated UCIs to encode, rate match, and map.

In some aspects, the BS 105 may communicate with a UE 115 using HARQ techniques to improve communication reliability, for example, to provide a URLLC service. The BS 105 may schedule a UE 115 for a PDSCH communication by transmitting a DL grant in a PDCCH. The BS 105 may transmit a DL data packet to the UE 115 according to the schedule in the PDSCH. The DL data packet may be transmitted in the form of a transport block (TB). If the UE 115 receives the DL data packet successfully, the UE 115 may transmit a HARQ ACK to the BS 105. Conversely, if the UE 115 fails to receive the DL transmission successfully, the UE 115 may transmit a HARQ NACK to the BS 105. Upon receiving a HARQ NACK from the UE 115, the BS 105 may retransmit the DL data packet to the UE 115. The retransmission may include the same coded version of DL data as the initial transmission. Alternatively, the retransmission may include a different coded version of the DL data than the initial transmission. The UE 115 may apply soft combining to combine the encoded data received from the initial transmission and the retransmission for decoding. The BS 105 and the UE 115 may also apply HARQ for UL communications using substantially similar mechanisms as the DL HARQ.

In some aspects, the network 100 may operate over a system BW or a component carrier (CC) BW. The network 100 may partition the system BW into multiple BWPs (e.g., portions). A BS 105 may dynamically assign a UE 115 to operate over a certain BWP (e.g., a certain portion of the system BW). The assigned BWP may be referred to as the active BWP. The UE 115 may monitor the active BWP for signaling information from the BS 105. The BS 105 may schedule the UE 115 for UL or DL communications in the active BWP. In some aspects, a BS 105 may assign a pair of BWPs within the CC to a UE 115 for UL and DL communications. For example, the BWP pair may include one BWP for UL communications and one BWP for DL communications.

In some aspects, the network 100 may operate over a shared channel, which may include shared frequency bands and/or unlicensed frequency bands. For example, the network 100 may be an NR-U network operating over an unlicensed frequency band. In such an aspect, the BSs 105 and the UEs 115 may be operated by multiple network operating entities. To avoid collisions, the BSs 105 and the UEs 115 may employ a listen-before-talk (LBT) procedure to monitor for transmission opportunities (TXOPs) in the shared channel. A TXOP may also be referred to as COT. The goal of LBT is to protect reception at a receiver from interference. For example, a transmitting node (e.g., a BS 105 or a UE 115) may perform an LBT prior to transmitting in the channel. When the LBT passes, the transmitting node may proceed with the transmission. When the LBT fails, the transmitting node may refrain from transmitting in the channel.

An LBT can be based on energy detection (ED) or signal detection. For an energy detection-based LBT, the LBT results in a pass when signal energy measured from the channel is below a threshold. Conversely, the LBT results in a failure when signal energy measured from the channel exceeds the threshold. For a signal detection-based LBT, the LBT results in a pass when a channel reservation signal (e.g., a predetermined preamble signal) is not detected in the channel.

Additionally, an LBT may be in a variety of modes. An LBT mode may be, for example, a category 4 (CAT4) LBT, a category 2 (CAT2) LBT, or a category 1 (CAT1) LBT. A CAT1 LBT is referred to a no LBT mode, where no LBT is to be performed prior to a transmission. A CAT2 LBT refers to an LBT without a random backoff period. For instance, a transmitting node may determine a channel measurement in a time interval and determine whether the channel is available or not based on a comparison of the channel measurement against a ED threshold. A CAT4 LBT refers to an LBT with a random backoff and a variable contention window (CW). For instance, a transmitting node may draw a random number and backoff for a duration based on the drawn random number in a certain time unit.

Deployment of communication systems, such as 5G new radio (NR) systems, may be arranged in multiple manners with various components or constituent parts. In a 5G NR system, or network, a network node, a network entity, a network unit, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS 105 (such as a Node B (NB), evolved NB (eNB), NR BS, 5G NB, access point (AP), a transmission and reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

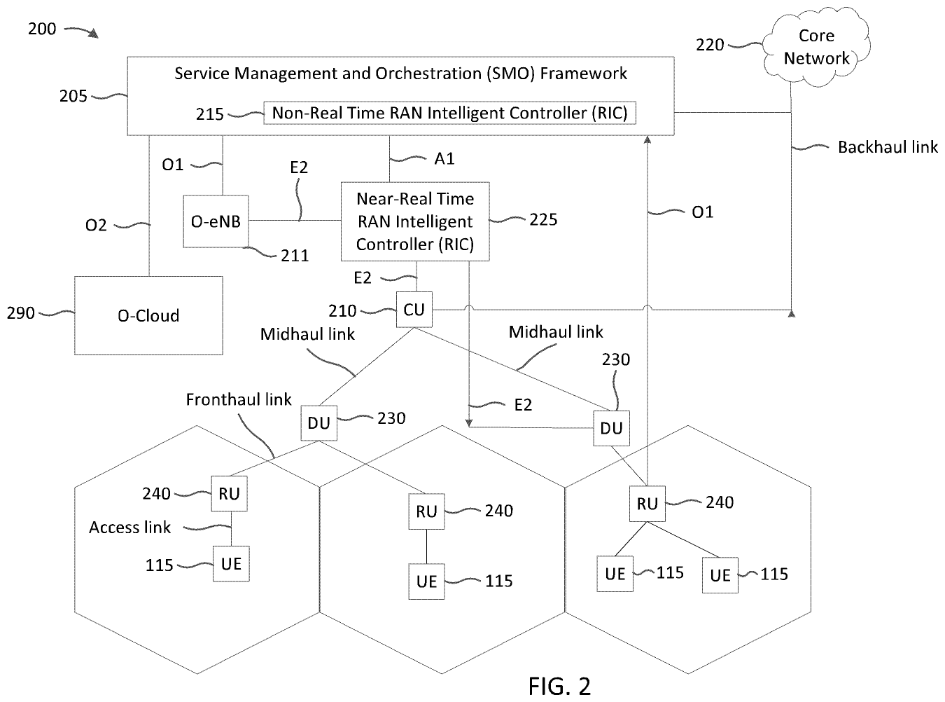

FIG. 2 shows a diagram illustrating an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 115 via one or more radio frequency (RF) access links. In some implementations, the UE 115 may be simultaneously served by multiple RUs 240.

Each of the units, i.e., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (i.e., Central Unit-User Plane (CU-UP)), control plane functionality (i.e., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communication with one or more UEs 115. In some implementations, real-time and non-real-time aspects of control and user plane communication with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

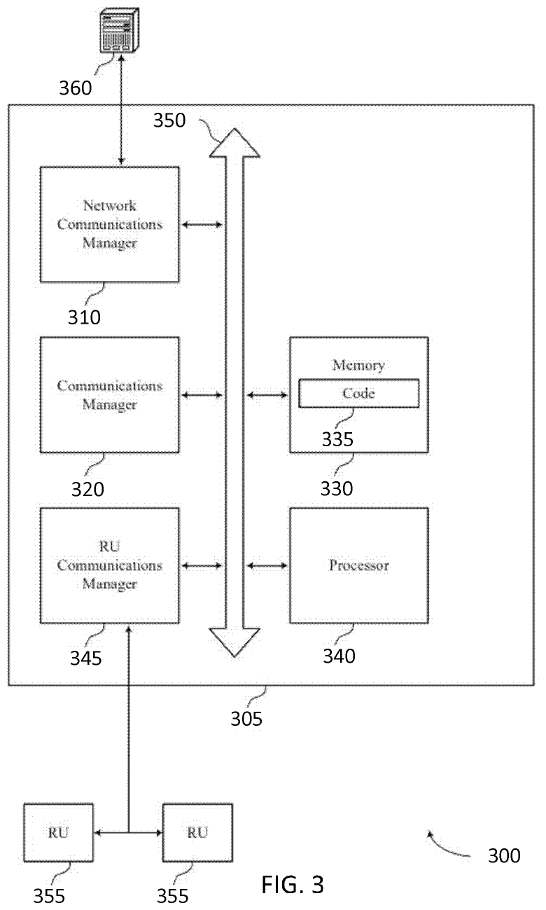

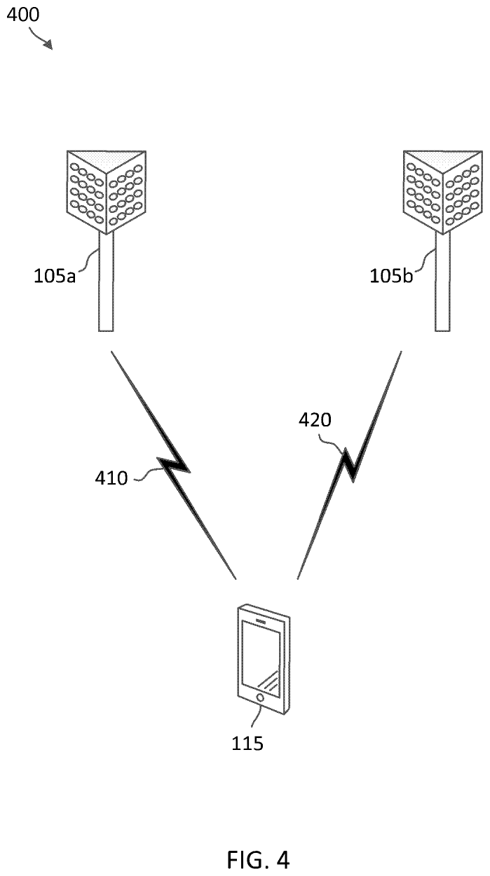

FIG. 3 shows a diagram of a system 300 including a device 305 that supports RU sharing techniques in wireless communications in accordance with aspects of the present disclosure. The device 305 may communicate with one or more RUs 355. The device 305 may include components for bi-directional voice and data communications including components for transmitting and receiving communications, such as a communications manager 320, a network communications manager 310, a memory 330, code 335, a processor 340, and a RU communications manager 345. These components may be in electronic communication or otherwise coupled (e.g., operatively, communicatively, functionally, electronically, electrically) via one or more buses (e.g., a bus 350). One or more of the components of system 300 may perform functions as described herein with reference to FIGS. 4-15, for example functions described as performed by a base station or network unit.

The network communications manager 310 may manage communications with a core network 360 (e.g., via one or more wired backhaul links). For example, the network communications manager 310 may manage the transfer of data communications for client devices, such as one or more UEs 115.

The memory 330 may include RAM and ROM. The memory 330 may store computer-readable, computer-executable code 335 including instructions that, when executed by the processor 340, cause the device 305 to perform various functions described herein. The code 335 may be stored in a non-transitory computer-readable medium such as system memory or another type of memory. In some cases, the code 335 may not be directly executable by the processor 340 but may cause a computer (e.g., when compiled and executed) to perform functions described herein. In some cases, the memory 330 may contain, among other things, a BIOS which may control basic hardware or software operation such as the interaction with peripheral components or devices.

The processor 340 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 340 may be configured to operate a memory array using a memory controller. In some other cases, a memory controller may be integrated into the processor 340. The processor 340 may be configured to execute computer-readable instructions stored in a memory (e.g., the memory 330) to cause the device 305 to perform various functions (e.g., functions or tasks supporting RU sharing techniques in wireless communications). For example, the device 305 or a component of the device 305 may include a processor 340 and memory 330 coupled to the processor 340, the processor 340 and memory 330 configured to perform various functions described herein.

The RU communications manager 345 may manage communications with RUs 355, and may include a controller or scheduler for controlling communications with UEs 115 in cooperation with RUs 355. For example, the RU communications manager 345 may coordinate scheduling for transmissions to UEs 115. In some examples, the RU communications manager 345 may provide an F1 interface within a wireless communications network technology to provide communication with RUs 355.

The communications manager 320 may support wireless communications at a network node in accordance with examples as disclosed herein. For example, the communications manager 320 may be configured as or otherwise support a means for transmitting, to a first RU, a request for a wireless resource configuration for a first time period. The communications manager 320 may be configured as or otherwise support a means for transmitting, to a second RU, an interference inquiry associated with the wireless resource configuration for the first time period. The communications manager 320 may be configured as or otherwise support a means for receiving, from the second RU, a response to the interference inquiry. The communications manager 320 may be configured as or otherwise support a means for transmitting, based on the response to the interference inquiry, a payload to the first RU for transmission during the first time period.

By including or configuring the communications manager 320 in accordance with examples as described herein, the device 305 may support techniques for RU sharing in which DUs of different MNOs may access wireless resources of other MNOs, which may increase efficiency of resource usage while provide for competition and innovation among different MNOs, may increase the reliability of wireless communications, decrease latency, and enhance user experience.

In some examples, the communications manager 320 may be configured to perform various operations (e.g., receiving, monitoring, transmitting) using or otherwise in cooperation with other components. Although the communications manager 320 is illustrated as a separate component, in some examples, one or more functions described with reference to the communications manager 320 may be supported by or performed by the processor 340, the memory 330, the code 335, or any combination thereof. For example, the code 335 may include instructions executable by the processor 340 to cause the device 305 to perform various aspects of RU sharing techniques in wireless communications as described herein, or the processor 340 and the memory 330 may be otherwise configured to perform or support such operations.

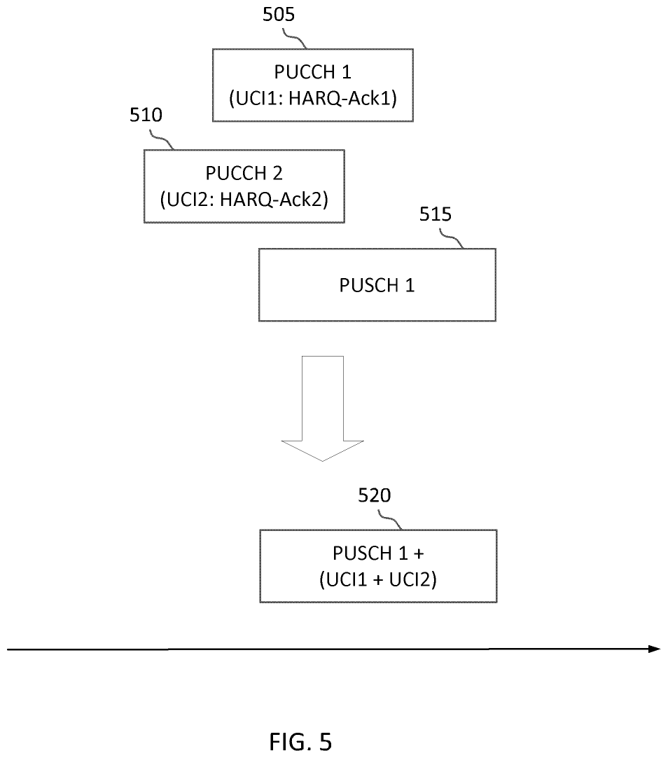

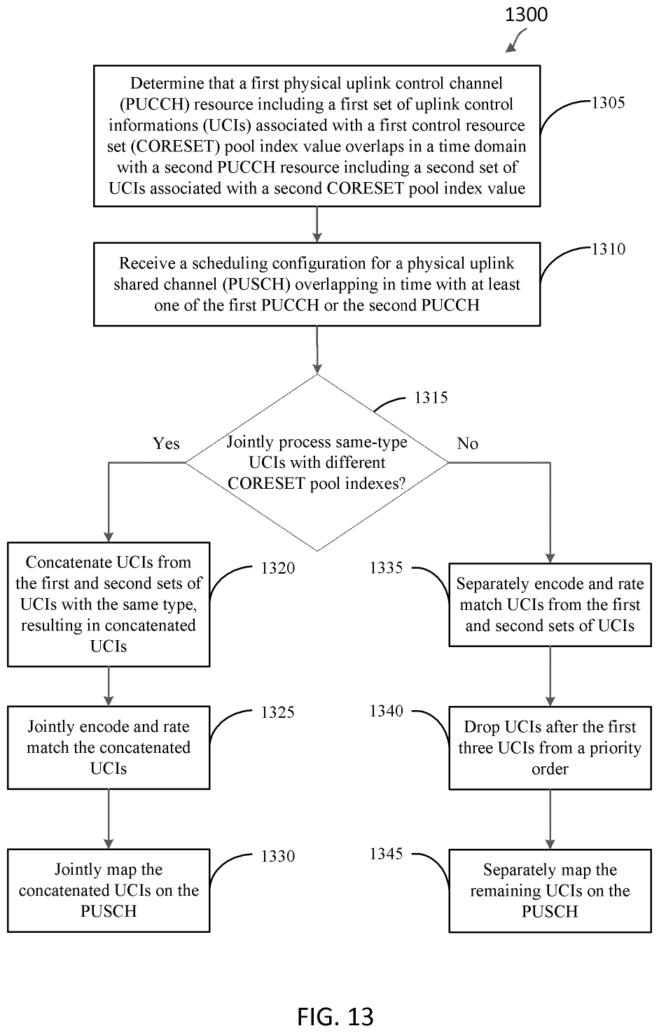

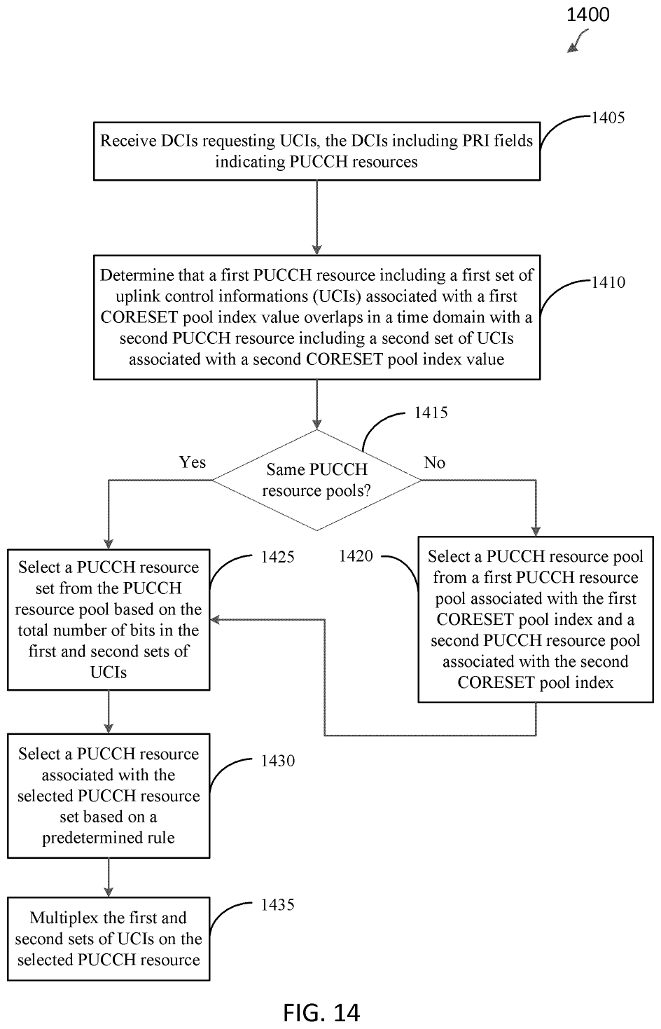

FIG. 4 illustrates an example wireless communication network according to some aspects of the present disclosure. As illustrated, UE 115 is in communication with network unit 105 via communication channel 410. UE 115 is also in communication at the same time with network unit 105b via communication channel 420. As discussed further herein with reference to FIGS. 5-15, UE 115 may receive messages from multiple network units such as network units 105a and 105b requesting UCIs. When the UCIs are scheduled with overlapping PUCCHs and/or an overlapping PUSCH, they may be multiplexed onto a single PUCCH or PUSCH resource based on predetermined rules as described with reference to FIGS. 13-14.

FIG. 5 illustrates an example resource diagram according to some aspects of the present disclosure. The horizontal axis represents time in some units, and the blocks represent communication resources scheduled between a UE and a network unit. In this example, PUCCH resources 505 and 510 are scheduled at overlapping times. PUCCHs 505 and 510 are each associated with a different network unit (e.g., TRP). PUSCH 515 is also overlapping in time both PUCCH resources 505 and 510, and may be associated with one of the same network units as PUCCH 505 or 510. PUCCH 505 is scheduled to transmit UCI1 which is a HARQ-Ack UCI type. PUCCH 510 is scheduled to transmit UCI2 which is also a HARQ-Ack UCI type. The UE 115 may multiplex UCI1 and UCI2 on the PUSCH 515, resulting in PUSCH 520 as shown which contains UCI1 and UCI2. In this way, the UE may transmit the UCIs even in circumstances where simultaneous PUCCH and PUSCH transmission is not permissible. Multiplexing PUCCHs on PUSCH across different network units is discussed in more detail with reference to FIG. 13.

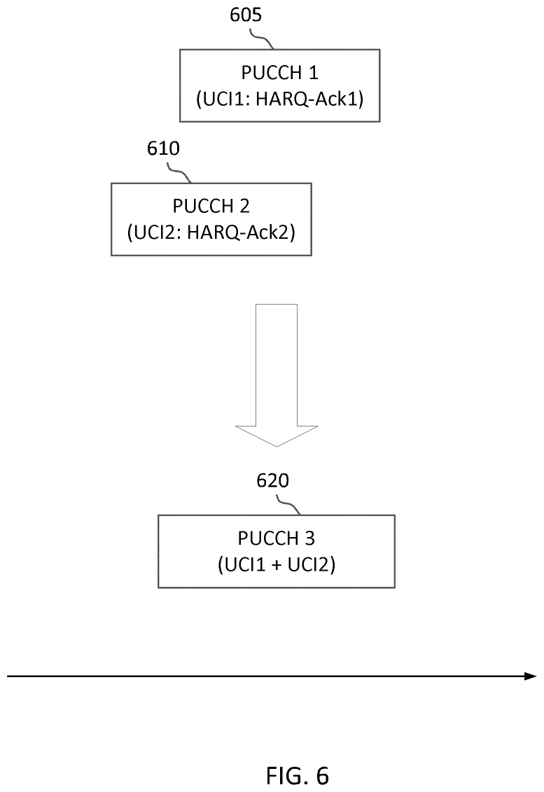

FIG. 6 illustrates an example resource diagram according to some aspects of the present disclosure. The horizontal axis represents time in some units, and the blocks represent communication resources scheduled between a UE and a network unit. In this example, PUCCH resources 605 and 610 are scheduled at overlapping times. PUCCHs 605 and 610 are each associated with a different network unit (e.g., TRP). PUCCH 605 is scheduled to transmit UCI1 which is a HARQ-Ack UCI type. PUCCH 610 is scheduled to transmit UCI2 which is also a HARQ-Ack UCI type. The UE 115 may multiplex UCI1 and UCI2 on PUCCH 620. PUCCH 620 may be a different resource than either PUCCH 605, or PUCCH 610. Multiplexing PUCCHs across different network units is discussed in more detail with reference to FIG. 14.

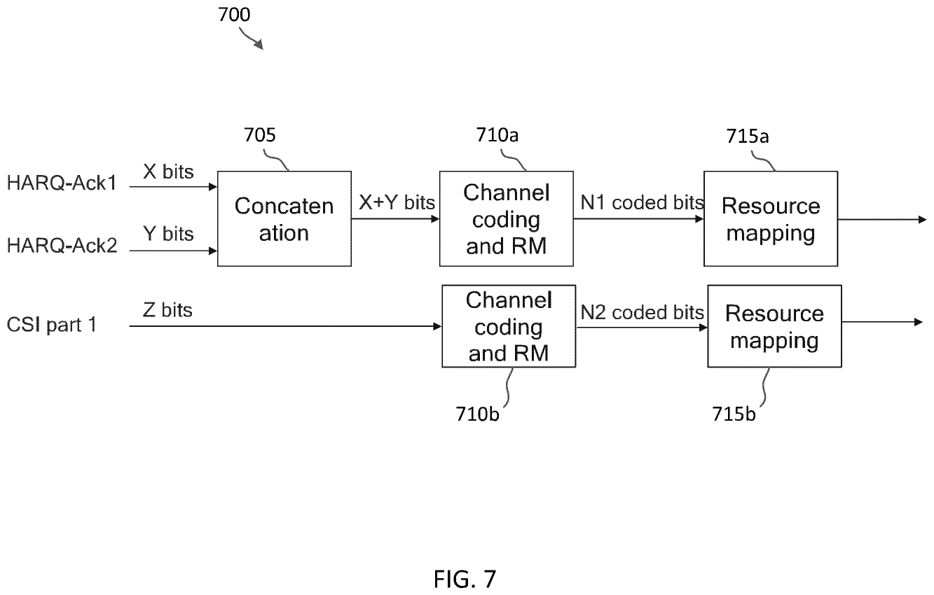

FIG. 7 illustrates an example process flow diagram 700 according to some aspects of the present disclosure. Diagram 700 represents the process internal to a UE 115 for multiplexing UCIs on a PUSCH. In the example of FIG. 7, a UCI of a certain type (e.g. HARQ-Ack) associated with a first network unit is concatenated with a UCI of the same type associated with a second network unit by concatenation block 705. If UCI1 contains X bits and UCI2 contains Y bits, then the concatenation results in X+Y total bits. CSI part 1 does not have a corresponding UCI associated with another network unit to concatenate with, so it is processed separately. The concatenated UCI1 and UCI2 are jointly encoded and rate matched by channel coding and rate matching block 710a. The concatenated UCI1 and UCI2 are then mapped by resource mapping block 715a to a PUSCH. CSI part 1 is channel coded and rate matched separately by channel coding and rate matching block 710b, and then resource mapped to the PUSCH by resource mapping block 715b.

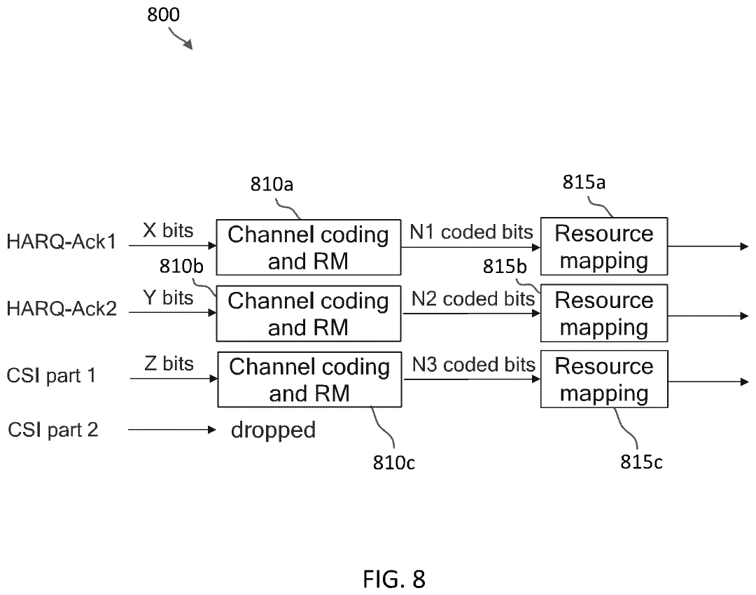

FIG. 8 illustrates an example process flow diagram 800 according to some aspects of the present disclosure. Diagram 800 represents the process internal to a UE 115 for multiplexing UCIs on a PUSCH. In the example of FIG. 8, a UE is determined to multiplex four UCIs of different types (two HARQ-Ack, a CSI part 1, and a CSI part 2) to a PUSCH. In this example, the HARQ-Ack associated with different CORESET pool index values are considered as different UCI types. Each of the UCIs are channel coded, rate matched, and mapped separately. Based on UE capability, there may only be a limited number of processing chains (e.g. . . . 3 chains), in which cause excess UCIs may be dropped. In this example, CSI part 2 is dropped. The UCIs may be ordered based on a priority rule such that the highest priority UCIs are not dropped before lower priority UCIs. In this example, HARQ-Ack associated with the first CORESET pool index is taken as HARQ-Ack, HARQ-Ack associated with the second CORESET pool index is taken as CSI part 1, and CSI part 1 is taken as CSI part 2. Thus HARQ-Ack1 is encoded and rate matched by channel coding and rate matching block 810a, and then mapped to a PUSCH by resource mapping block 815a. HARQ-Ack2 is encoded and rate matched by channel coding and rate matching block 810b, and then mapped to a PUSCH by resource mapping block 815b. CSI part 1 is encoded and rate matched by channel coding and rate matching block 810c, and then mapped to a PUSCH by resource mapping block 815c. CSI part 2 is dropped.

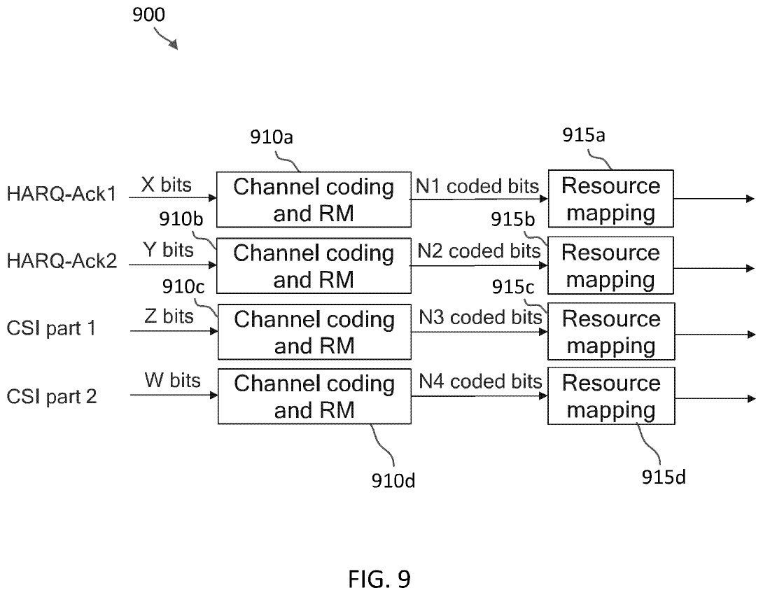

FIG. 9 illustrates an example process flow diagram 900 according to some aspects of the present disclosure. Diagram 900 represents the process internal to a UE 115 for multiplexing UCIs on a PUSCH. In the example of FIG. 9, a UE is scheduled to transmit four UCIs of different types (two HARQ-Ack, a CSI part 1, and a CSI part 2). Each of the UCIs are channel coded, rate matched, and mapped separately. In this example, the UE has the capability of processing more than three UCIs separately, therefore CSI part 2 may not be dropped as it was in the example of FIG. 8. The order of the UCI mapping is defined as follows: HARQ-Ack associated with the first CORESET pool index higher than the HARQ-Ack associated with the second CORESET pool index, then CSI part 1 associated with a first CORESET pool index, then CSI part 1 associated with the second CORESET pool index, then CSI part 2 associated with the first CORESET pool index, and then CSI part 2 associated with the second CORESET pool index. For CSI part 1 and CSI part 2, if the association with CORESET pool index is not configured, a default CORESET pool index is assumed, e.g., CORESET pool index value 0. In this example, HARQ-Ack1 is encoded and rate matched by channel coding and rate matching block 910a, and then mapped to a PUSCH by resource mapping block 915a. HARQ-Ack2 is encoded and rate matched by channel coding and rate matching block 910b, and then mapped to a PUSCH by resource mapping block 915b. CSI part 1 is encoded and rate matched by channel coding and rate matching block 910c, and then mapped to a PUSCH by resource mapping block 915c. CSI part 2 is encoded and rate matched by channel coding and rate matching block 910d, and then mapped to a PUSCH by resource mapping block 915d.

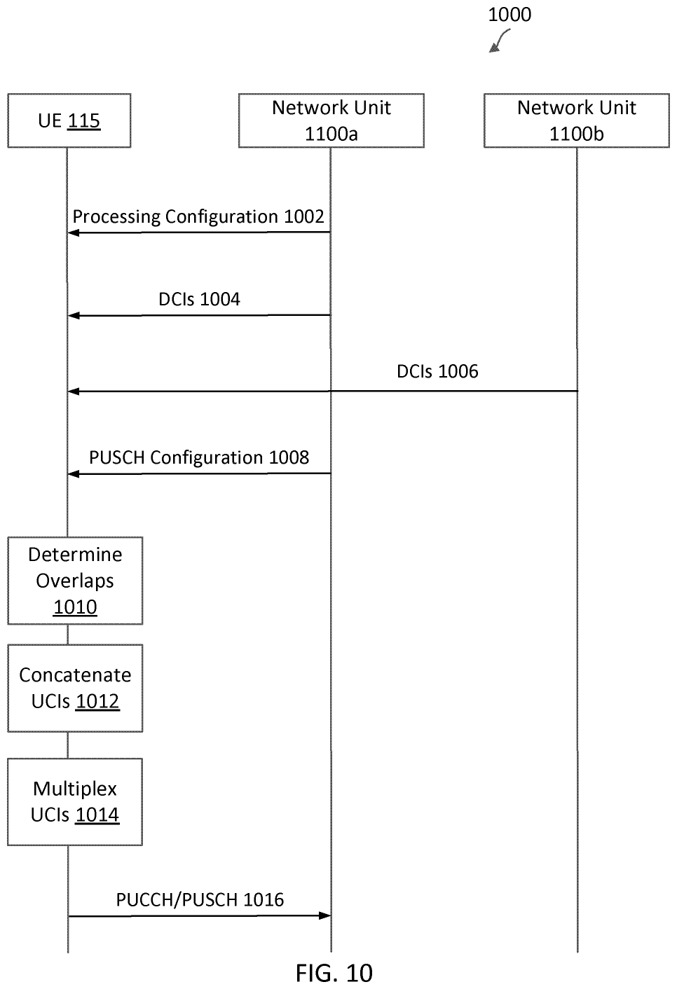

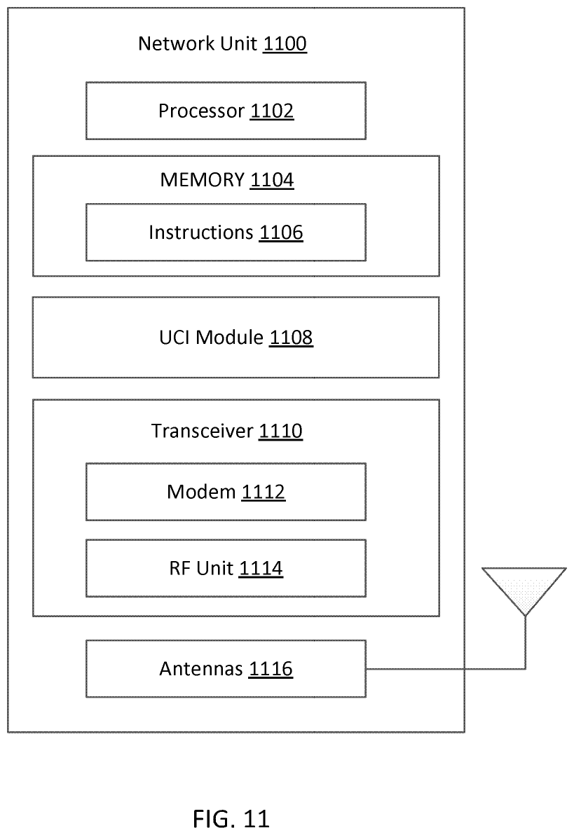

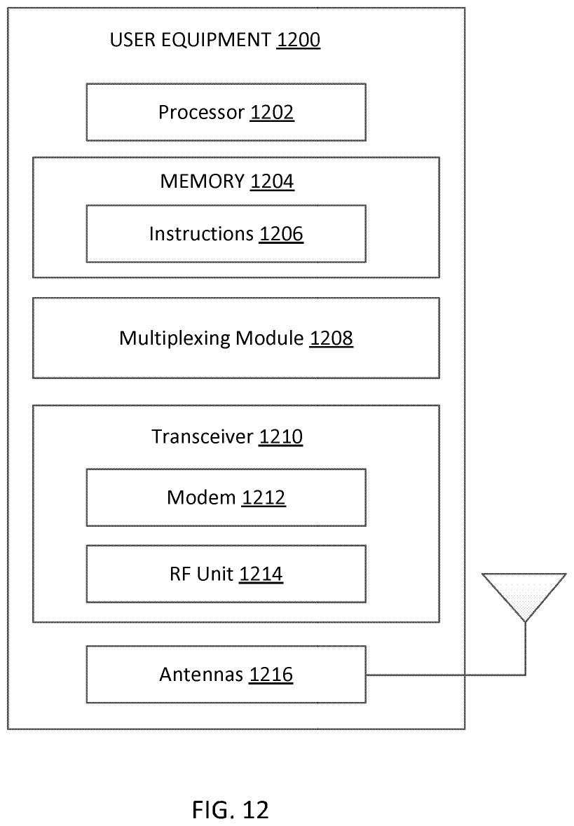

FIG. 10 is a signaling diagram 1000 according to some aspects of the present disclosure. The diagram 1000 is employed by network units 1100a and 1100b such as the BS 105, discussed with reference to FIG. 1, one or more components of disaggregated base station 200 (e.g., CU 210, DU 230, and/or RU 240) discussed with reference to FIGS. 2-3. Network units 1100a and 100b may utilize one or more components, such as the processor 1102, the memory 1104, the UCI module 1108, the transceiver 1110, the modem 1112, and the one or more antennas 1116 shown in FIG. 11. UE 115 may utilize one or more components, such as the processor 1202, the memory 1204, the multiplexing module 1208, the transceiver 1210, the modem 1212, and the one or more antennas 1216 shown in FIG. 12. As illustrated, the signaling diagram 1000 includes a number of enumerated actions, but aspects of FIG. 10 may include additional actions before, after, and in between the enumerated actions. In some aspects, one or more of the enumerated actions may be omitted, combined together, or performed in a different order.

At action 1002, network unit 1100a transmits a processing configuration to UE 115. The processing configuration may indicate, for example, whether to jointly or separately process UCIs of the same type associated with different CORESET pool index values.

At action 1004, network unit 1100a transmits multiple DCI messages to UE 115. The DCIs may have PRI fields associated with them indicating PUCCH resources. The DCIs may request UCIs from UE 115 of different UCI types.

At action 1006, network unit 1100b also transmits multiple DCI messages to UE 115. The DCIs may have PRI fields associated with them indicating PUCCH resources which may overlap the PUCCH resources indicated by the DCIs transmitted by network unit 1100a. The DCIs may request UCIs from UE 115 of different UCI types.

At action 1008, network unit 1100a transmits a PUSCH configuration to UE 115. The PUSCH configuration may be communicated dynamically (e.g., via DCI), or semi-statically (e.g., via configured grant). The PUSCH resource may overlap in time with one or more of the scheduled PUCCH resources.

At action 1010, UE 115 determines overlapping resources. For example, one or more PUCCH resources scheduled at actions 1004 and 1006 may overlap, and one or more of those PUCCH resources may overlap with a PUSCH resource as configured at action 1008. If there is not overlap as determined by the UE, then the UE may transmit data using the resources as originally scheduled.

At action 1012, UE 115 may concatenate UCIs with overlapping PUCCH resources associated with the different network units 1100. In some aspects, UCIs of the same type are concatenated, as described with reference to FIG. 7. In some aspects, UCIs are not concatenated, but processed separately. Depending on UE capability, UCIs may need to be dropped, in which case they may be dropped in a priority order as discussed with reference to FIG. 8.

At action 1014, the UCIs are multiplexed by UE 115 to a PUCCH or to the PUSCH if the PUSCH is overlapping with one or more of the PUCCH resources.

At action 1016, network unit 1100a receives a PUCCH or a PUSCH from UE 115. The PUCCH or PUSCH may include all or a subset of the UCIs requested in the DCI messages.

FIG. 11 is a block diagram of an exemplary network unit 1100 according to some aspects of the present disclosure. The network unit 1100 may be a BS 105 as discussed in FIG. 1, or be made up of disaggregated units as described with reference to FIGS. 2-3. Network unit 1100 may be a transmission and reception point (TRP). As shown, the network unit 1100 may include a processor 1102, a memory 1104, an UCI module 1108, a transceiver 1110 including a modem subsystem 1112 and a RF unit 1114, and one or more antennas 1116. These elements may be coupled with one another. The term “coupled” may refer to directly or indirectly coupled or connected to one or more intervening elements. For instance, these elements may be in direct or indirect communication with each other, for example via one or more buses.

The processor 1102 may have various features as a specific-type processor. For example, these may include a CPU, a DSP, an ASIC, a controller, a FPGA device, another hardware device, a firmware device, or any combination thereof configured to perform the operations described herein. The processor 1102 may also be implemented as a combination of computing devices, e.g., a combination of a DSP and a microprocessor, a plurality of microprocessors, one or more microprocessors in conjunction with a DSP core, or any other such configuration.

The memory 1104 may include a cache memory (e.g., a cache memory of the processor 1102), RAM, MRAM, ROM, PROM, EPROM, EEPROM, flash memory, a solid-state memory device, one or more hard disk drives, memristor-based arrays, other forms of volatile and non-volatile memory, or a combination of different types of memory. In some aspects, the memory 1104 may include a non-transitory computer-readable medium. The memory 1104 may store instructions 1106. The instructions 1106 may include instructions that, when executed by the processor 1102, cause the processor 1102 to perform operations described herein, for example, aspects of FIGS. 4-10 and 13-15. Instructions 1106 may also be referred to as program code. The program code may be for causing a wireless communication device to perform these operations, for example by causing one or more processors (such as processor 1102) to control or command the wireless communication device to do so. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The UCI module 1108 may be implemented via hardware, software, or combinations thereof. For example, the UCI module 1108 may be implemented as a processor, circuit, and/or instructions 1106 stored in the memory 1104 and executed by the processor 1102. In some examples, the UCI module 1108 can be integrated within the modem subsystem 1112. For example, the UCI module 1108 can be implemented by a combination of software components (e.g., executed by a DSP or a general processor) and hardware components (e.g., logic gates and circuitry) within the modem subsystem 1112. The UCI module 1108 may communicate with one or more components of network unit 1100 to implement various aspects of the present disclosure, for example, aspects of FIGS. 4-10 and 13-15.

In some aspects, the UCI module 1108 may be configured to receive, from a UE, a rank indicator (RI). The RI may be received as part of channel state feedback information. The channel state feedback may be received, for example, via an RRC message, UL MAC CE, channel state information (CSI) message, a synchronization signal block (SSB), or other suitable communication, using PUCCH, PSCCH, or another suitable channel. The channel state feedback information may include a precoding matrix indicator (PMI) and/or a channel quality indicator (CQI) corresponding to the RI. The RI may define the number of possible transmission layers for the downlink transmission under specific channel conditions. The RI may correspond to a maximum number of uncorrelated paths that can be used for downlink transmission. The RI, however, may not contain information directly related to the number of antenna panels or modules used by the UE in achieving the indicated RI.

The UCI module 1108 may be configured to request UCIs of different types from a UE. The UCI requests may be transmitted via PDCCH in DCI messages indicating PUCCH resources. The UCI module 1108 may receive the UCIs from the UE multiplexed onto a single PUCCH or PUSCH message.

As shown, the transceiver 1110 may include the modem subsystem 1112 and the RF unit 1114. The transceiver 1110 can be configured to communicate bi-directionally with other devices, such as the UEs 115 and/or BS 105 and/or another core network element. The modem subsystem 1112 may be configured to modulate and/or encode data according to a MCS, e.g., a LDPC coding scheme, a turbo coding scheme, a convolutional coding scheme, a digital beamforming scheme, etc. The RF unit 1114 may be configured to process (e.g., perform analog to digital conversion or digital to analog conversion, etc.) modulated/encoded data (e.g., PDCCH DCI, RRC, etc.) from the modem subsystem 1112 (on outbound transmissions) or of transmissions originating from another source such as a UE 115, and/or UE 1200. The RF unit 1114 may be further configured to perform analog beamforming in conjunction with the digital beamforming. Although shown as integrated together in transceiver 1110, the modem subsystem 1112 and/or the RF unit 1114 may be separate devices that are coupled together at the network unit 1100 to enable the network unit 1100 to communicate with other devices.

The RF unit 1114 may provide the modulated and/or processed data, e.g. data packets (or, more generally, data messages that may contain one or more data packets and other information), to the antennas 1116 for transmission to one or more other devices. The antennas 1116 may further receive data messages transmitted from other devices and provide the received data messages for processing and/or demodulation at the transceiver 1110. The transceiver 1110 may provide the demodulated and decoded data (e.g., PUCCH, PUSCH, etc.) to the UCI module 1108 for processing. The antennas 1116 may include multiple antennas of similar or different designs in order to sustain multiple transmission links.

In an aspect, the network unit 1100 can include multiple transceivers 1110 implementing different RATs (e.g., NR and LTE). In an aspect, the network unit 1100 can include a single transceiver 1110 implementing multiple RATs (e.g., NR and LTE). In an aspect, the transceiver 1110 can include various components, where different combinations of components can implement different RATs.

FIG. 12 is a block diagram of an exemplary UE 1200 according to some aspects of the present disclosure. The UE 1200 may be a UE 115 as discussed in FIGS. 1-4. As shown, the UE 1200 may include a processor 1202, a memory 1204, a multiplexing module 1208, a transceiver 1210 including a modem subsystem 1212 and a radio frequency (RF) unit 1214, and one or more antennas 1216. These elements may be coupled with one another. The term “coupled” may refer to directly or indirectly coupled or connected to one or more intervening elements. For instance, these elements may be in direct or indirect communication with each other, for example via one or more buses.

The processor 1202 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 1202 may also be implemented as a combination of computing devices, e.g., a combination of a DSP and a microprocessor, a plurality of microprocessors, one or more microprocessors in conjunction with a DSP core, or any other such configuration.

The memory 1204 may include a cache memory (e.g., a cache memory of the processor 1202), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an aspect, the memory 1204 includes a non-transitory computer-readable medium. The memory 1204 may store, or have recorded thereon, instructions 1206. The instructions 1206 may include instructions that, when executed by the processor 1202, cause the processor 1202 to perform the operations described herein with reference to a UE 115 in connection with aspects of the present disclosure, for example, aspects of FIGS. 4-10 and 13-14. Instructions 1206 may also be referred to as code, which may be interpreted broadly to include any type of computer-readable statement(s).

The multiplexing module 1208 may be implemented via hardware, software, or combinations thereof. For example, the multiplexing module 1208 may be implemented as a processor, circuit, and/or instructions 1206 stored in the memory 1204 and executed by the processor 1202. In some aspects, the multiplexing module 1208 can be integrated within the modem subsystem 1212. For example, the multiplexing module 1208 can be implemented by a combination of software components (e.g., executed by a DSP or a general processor) and hardware components (e.g., logic gates and circuitry) within the modem subsystem 1212. The multiplexing module 1208 may communicate with one or more components of UE 1200 to implement various aspects of the present disclosure, for example, aspects of FIGS. 4-10 and 13-14.

In some aspects, multiplexing module 1208 may be configured to multiplex PUCCH messages with UCIs with an overlapping PUCCH or PUSCH. A PUCCH resource may be scheduled for UE 1200 to transmit a UCI. A CORESET may indicate to multiplexing module 1208 resources for receiving PDCCH messages (e.g., DCI). Each CORESET can be configured with a value of CORESET pool index (e.g., via parameters CORESETPoolIndex). For example CORESET IDs 1 and 2 may be associated with CORESET pool index 0, and CORESET IDs 3 and 4 may be associated with CORESET pool index 1. As such, multiplexing module 1208 may identify which TRP is sending a message to the UE 1200, as each CORESET pool index may be associated with a different TRP. Also associated with CORESET pool indexes are PUCCH resource pools. A PUCCH resource pool is comprised of a number of PUCCH resource sets, and a PUCCH resource set is comprised of a number of PUCCH resources. In some instances, a PUCCH resource set is determined by multiplexing module 1208 based on the number of bits in the UCI to be transmitted on the resource. The PUCCH resource from the resource say may be determined based on a PUCCH resource indicator (PRI) field in the DCI scheduling the PUCCH. When multiple PUCCHs are multiplexed, however, different rules may be implemented by multiplexing module 1208 for determining PUCCH resources pools, PUCCH resource sets, and PUCCH resources, as described further herein with reference to FIGS. 4-10 and 13-14. Based on the determined resources for transmitting the UCIs, multiplexing module 1208 may encode, rate match, and map the UCIs to the determined resource.

As shown, the transceiver 1210 may include the modem subsystem 1212 and the RF unit 1214. The transceiver 1210 can be configured to communicate bi-directionally with other devices, such as the BSs 105 and 500. The modem subsystem 1212 may be configured to modulate and/or encode the data from the memory 1204 and/or the multiplexing module 1208 according to a modulation and coding scheme (MCS), e.g., a low-density parity check (LDPC) coding scheme, a turbo coding scheme, a convolutional coding scheme, a digital beamforming scheme, etc. The RF unit 1214 may be configured to process (e.g., perform analog to digital conversion or digital to analog conversion, etc.) modulated/encoded data (e.g., PUCCH, PUSCH, etc.) or of transmissions originating from another source such as a UE 115, or a BS 105. The RF unit 1214 may be further configured to perform analog beamforming in conjunction with the digital beamforming. Although shown as integrated together in transceiver 1210, the modem subsystem 1212 and the RF unit 1214 may be separate devices that are coupled together at the UE 1200 to enable the UE 1200 to communicate with other devices.

The RF unit 1214 may provide the modulated and/or processed data, e.g., data packets (or, more generally, data messages that may contain one or more data packets and other information), to the antennas 1216 for transmission to one or more other devices. The antennas 1216 may further receive data messages transmitted from other devices. The antennas 1216 may provide the received data messages for processing and/or demodulation at the transceiver 1210. The transceiver 1210 may provide the demodulated and decoded data (e.g., PDCCH DCI, RRC, etc.) to the multiplexing module 1208 for processing. The antennas 1216 may include multiple antennas of similar or different designs in order to sustain multiple transmission links. Antennas 1216 may include multiple antenna modules, each associated with a different antenna panel. Antenna panels may be used to transmit and/or receive using beamforming techniques.

In an aspect, the UE 1200 can include multiple transceivers 1210 implementing different RATs (e.g., NR and LTE). In an aspect, the UE 1200 can include a single transceiver 1210 implementing multiple RATs (e.g., NR and LTE). In an aspect, the transceiver 1210 can include various components, where different combinations of components can implement different RATs.

FIG. 13 is a flow diagram illustrating a wireless communication method 1300 according to some aspects of the present disclosure. Aspects of the method 1300 can be executed by a computing device (e.g., a processor, processing circuit, and/or other suitable component) of a wireless communication device or other suitable means for performing the blocks. In one aspect, a UE 115, or 1200, may perform the method 1300 utilizing components such as the processor 1202, the memory 1204, the multiplexing module 1208, the transceiver 1210, the modem 1212, and the one or more antennas 1216 shown in FIG. 12.

As illustrated, the method 1300 includes a number of enumerated blocks, but aspects of the method 1300 may include additional blocks before, after, and in between the enumerated blocks. In some aspects, one or more of the enumerated blocks may be omitted or performed in a different order.

At block 1305, a UE (e.g., UE 115, UE 1200, or other UE) determines that a first PUCCH resource including a first set of UCIs associated with a first CORESET pool index value overlaps in a time domain with a second PUCCH resource including a second set of UCIs associated with a second CORESET pool index value. Each of the PUCCH resources may be associated with UE communication with a different network unit (e.g., TRP). The UE may determine that different network units are associated with each PUCCH based on the first and second CORESET pool index values being different from each other. In some examples, a CORESET pool index may have a value of 0 or 1, each value being associated with a different group of CORESETs. Each CORESET group defined by a CORESET pool index may be associated with a different network unit. When a UE receives a DCI in a monitoring period based on a CORESET associated with a first CORESET pool index, the UE may determine that the DCI is associated with a different network unit than a DCI received using a CORESET with a different CORESET pool index. The CORESET pool index of the CORESET in which a DCI is received may be used for different purposes such as for HARQ-Ack feedback.

The first and second sets of UCIs may include UCIs of different types. For example, UCI types may include HARQ-Ack, CSI (CSI part 1, and CSI part 2), SR, and any combinations thereof. The grouping of UCIs into first and second PUCCHs may be the result of a previous step involving resolving overlapping PUCCH resources scheduled via DCI. For example, a set of DCI messages from different TRPs or RRC message may each schedule a different UCI of a respective UCI type. The UE may determine that some of the UCI's PUCCH resources overlap, and may multiplex those UCIs such that the first PUCCH resource includes the first set of UCIs and the second PUCCH resource includes the second set of UCIs.

At block 1310, the UE receives a scheduling configuration for a physical uplink shared channel (PUSCH) overlapping in time with at least one of the first PUCCH or the second PUCCH. The scheduling configuration may be received from a network unit associated with the first or second PUCCH. The PUSCH may be scheduled dynamically (e.g., via a DCI), or may be scheduled semi-statically (e.g., via a configured grant). When configured semi-statically, the reception of the PUSCH configuration may occur at a time long prior to the other actions performed in method 1300. Simultaneous transmission of PUSCH and PUCCH may not be supported by the UE, so the overlapping of PUSCH and PUCCH in time may be resolved as follows.

At decision block 1315, the UE determines whether to jointly process (encode/rate-match/map) UCIs of the same type associated with different CORESET pool index values. In some aspects, the UE 115 does not actively make a determination as the decision to either concatenate or not is based on a standard rule which the UE is configured to always follow. In some aspects, a configuration (e.g., received via RRC) may be used to determine whether to jointly encode/rate-match/map UCIs of the same type associated with different CORESET pool index values. If the UE determines to concatenate, the method 1300 proceeds to block 1320, otherwise the method 1300 proceeds to block 1335.

At block 1320, the UE concatenates UCIs from the first and second sets of UCIs with the same type, resulting in concatenated UCIs. The concatenation may be based on increasing or decreasing order of the associated CORESET pool index values. For example, UCIs associated with lower relative CORESET pool index values may be included in the concatenated UCI before UCIs associated with a higher relative CORESET pool index.

At block 1325, the UE jointly encodes and rate matches the concatenated UCIs. UCIs of different types may be encoded and rate matched separately. The encoding and rate matching of block 1325 may be performed, for example, as described with reference to FIG. 7.

At block 1330, the UE jointly maps the concatenated UCIs on the PUSCH. UCIs which were separately encoded and rate matched may be separately mapped on the PUSCH.

At block 1335, when the UE determines not to jointly encode/rate-match/map UCIs of the same type associated with different CORESET pool index values, the UE separately encodes and rate matches UCIs from the first and second sets of UCIs. This may be done regardless of the relative UCI types of each UCI, for example as discussed with reference to FIGS. 8-9. The UE may use existing encoding/rate matching/mapping chains for HARQ-Ack, CSI part 1 and CSI part 2, while changing the inputs as desired. For example, rate matching for a first hybrid automatic repeat request acknowledgement (HARQ-ACK) associated with the first CORESET pool index value by taking the first HARQ-ACK as HARQ-ACK, performing rate matching for a second HARQ-ACK associated with the second CORESET pool index value by taking the second HARQ-ACK as a CSI part 1, and performing rate matching for a CSI part 1 by taking the CSI part 1 as a CSI part 2.

At block 1340, the UE drops UCIs after the first three UCIs from a priority order. The UE may only have the capability of three processing chains, allowing only three separate UCIs to be encoded, rate matched, and mapped at the same time. In the example above, a CSI part 2 may be dropped as two HARQ-Acks and a CSI part I utilize the three existing chains. Some UEs may have the capability of processing more or less UCIs. If more concurrent processing chains are available to the UE, the additional UCIs may not be dropped, as discussed with reference to FIG. 9. When dropping UCIs, which UCIs are dropped is determined based on a priority order. For example, HARQ-Acks and/or SR may have the highest priority, followed by CSI part 1 and then CSI part 2. When there are two UCIs of the same type associated with different CORESET pool indexes, which of the two gets priority may be based on a predetermined CORESET pool index. If a UCI such as a CSI part 1 or 2 is not associated with a CORESET pool index, then a default CORESET pool index may be assumed for the purpose of determining priority order.

At block 1345, the UE separately maps the remaining (i.e., not dropped) UCIs on the PUSCH.

FIG. 14 is a flow diagram illustrating a wireless communication method 1400 according to some aspects of the present disclosure. Aspects of the method 1400 can be executed by a computing device (e.g., a processor, processing circuit, and/or other suitable component) of a wireless communication device or other suitable means for performing the blocks. In one aspect, a UE 115, or 1200, may perform the method 1400 utilizing components such as the processor 1202, the memory 1204, the multiplexing module 1208, the transceiver 1210, the modem 1212, and the one or more antennas 1216 shown in FIG. 12.

As illustrated, the method 1400 includes a number of enumerated blocks, but aspects of the method 1400 may include additional blocks before, after, and in between the enumerated blocks. In some aspects, one or more of the enumerated blocks may be omitted or performed in a different order.

At block 1405, a UE (e.g., UE 115, UE 1200, or other UE) receives DCIs requesting UCIs, the DCIs including PRI fields indicating PUCCH resources. The DCIs may be received from different network units (e.g., TRPs). The UE may determine that the DCIs are from different network units based on DCIs being receives associated with CORESETs with different CORESET pool indexes.

At block 1410, the UE determines that a first PUCCH resource including a first set of UCIs associated with a first CORESET pool index value overlaps in a time domain with a second PUCCH resource including a second set of UCIs associated with a second CORESET pool index value. The first and second sets of UCIs may include UCIs of different types. For example, UCI types may include HARQ-Ack, CSI (CSI part 1, and CSI part 2), SR and any combinations thereof. The grouping of UCIs into first and second PUCCHs may be the result of a previous step involving resolving overlapping PUCCH resources scheduled via DCI. For example, a set of DCI messages from different TRPs may each schedule a different UCI of a respective UCI type. The UE may determine that some of the UCI's PUCCH resources overlap, and may multiplex those UCIs such that the first PUCCH resource includes the first set of UCIs and the second PUCCH resource includes the second set of UCIs.

At decision block 1415, the UE determines whether the PUCCH resource pool associated with the first CORESET pool index is the same as the PUCCH resource pool associated with the second CORESET pool index. For example, the UE may make a comparison of the two PUCCH resource pool values. In some aspects, the UE may not need to actively make a decision, but assumes either that the PUCCH resource pools are the same or different based on a standard rule. In some aspects, the UE determines whether the PUCCH resource pools are the same or different based on a configuration parameter previously received, for example from a TRP via RRC. If the UE determines or assumes that the PUCCH resource pools are different, then method 1400 proceeds to block 1420. If the UE determines or assumes that the PUCCH resource pools are the same, then the PUCCH pool is determined to be the common PUCCH resource pool, and method 1400 proceeds to block 1425.

At block 1420, the UE selects a PUCCH resource pool from a first PUCCH resource pool associated with the first CORESET pool index and a second PUCCH resource pool associated with the second CORESET pool index. In some aspects, the UE selects the PUCCH resource pool based on a fixed CORESET pool index value, for example the highest or lowest CORESET pool index value of the two PUCCH resource pools based on a standard or preconfigured rule. In other aspects, the UE selects the PUCCH resource pool based on the CORESET pool index value which is configured via an RRC message (e.g., received from one of the network units).

At block 1425, the UE selects a PUCCH resource set from the PUCCH resource pool based on the total number of bits in the first and second sets of UCIs. If the UE determined or assumed that the PUCCH resource pools are the same at block 1415, then the PUCCH resource pool is the one associated with both CORESET pool indexes, otherwise the PUCCH resource pool is the one selected at block 1420.

At block 1430, the UE selects a PUCCH resource associated with the selected PUCCH resource set based on a predetermined rule. When the PUCCH resource pool is different for both PUCCHs and the UE has selected the PUCCH resource pool at block 1420, then the predetermined rule may be to select the PUCCH resource indicated by the PRI field of the last DCI associated with the same CORESET pool index value as the determined PUCCH resource pool.

When the PUCCH resource pool associated with the first CORESET pool index is the same as the PUCCH resource pool associated with the second CORESET pool index, then the predetermined rule for selecting the PUCCH resource may be one of the following.

In some aspects, the predetermined rule may be to determine the PUCCH resource based on the PRI field in the last DCI associated with a fixed CORESET pool index value (e.g., value 1) among the last DCI indicating the first PUCCH and the last DCI indicating the second PUCCH. For example, if the fixed CORESET pool index value is 1, and the first PUCCH is associated with a CORESET pool index value of 0 and the second PUCCH is associated with a CORESET pool index value of 1, then the PUCCH resource would be determined based on the PRI value of the last DCI indicating the second PUCCH.

In other aspects, the predetermined rule may be to determine the PUCCH resource based on the PRI field in the last DCI indicating the lowest (or alternatively, the highest) PRI codepoint value among the last DCI indicating the first PUCCH and the last DCI indicating the second PUCCH. For example, if the last DCI indicating the first PUCCH had a PRI with a codepoint value of 2, and the last DCI indicating the second PUCCH had a PRI with a codepoint value of 4, and the predetermined rule was to select the lowest PRI codepoint value, then the PUCCH resource would be selected based on the PRI codepoint value of 2.

In yet further aspects, the predetermined rule may be to determine the PUCCH resource based on the PRI field in the last DCI among the first and second sets of DCIs (associated with both the first and second PUCCH). For example, if the last DCI indicating the first PUCCH was received during a PDCCH monitoring occasion before the last DCI indicating the second PUCCH was received, then the PUCCH resource would be determined based on the last DCI indicating the second PUCCH. However, in some instances, the last DCI indicating the first PUCCH and the last DCI indicating the second PUCCH may be received in the same PDCCH monitoring occasion. When this occurs, there may be a fallback rule for determining between the two last DCIs whose PRI value is to be used for determining the PUCCH resource. The fallback rule may be one of the following.

In some aspects, the fallback rule may be to determine the PUCCH resource based on the PRI field in the last DCI associated with a fixed CORESET pool index value (e.g., value 1) among the last DCI indicating the first PUCCH and the last DCI indicating the second PUCCH. For example, if the fixed CORESET pool index value is 1, and the first PUCCH is associated with a CORESET pool index value of 0 and the second PUCCH is associated with a CORESET pool index value of 1, then the PUCCH resource would be determined based on the PRI value of the last DCI indicating the second PUCCH.

In other aspects, the fallback rule may be to determine the PUCCH resource based on the PRI field in the last DCI indicating the lowest (or alternatively, the highest) PRI codepoint value among the last DCI indicating the first PUCCH and the last DCI indicating the second PUCCH. For example, if the last DCI indicating the first PUCCH had a PRI with a codepoint value of 2, and the last DCI indicating the second PUCCH had a PRI with a codepoint value of 4, and the predetermined rule was to select the highest PRI codepoint value, then the PUCCH resource would be selected based on the PRI codepoint value of 4.

In yet further aspects, the fallback rule may be to determine the PUCCH resource based on the PRI field of the last DCI indicating the first PUCCH or the last DCI indicating the second PUCCH associated with a highest or lowest CORESET ID relative to the other. For example, if the last DCI indicating the first PUCCH had a higher CORESET ID relative to the last DCI indicating the second PUCCH, and the predetermined rule was to select the highest CORESET ID, then the PUCCH resource would be selected based on the PRI of the last DCI indicating the first PUCCH.

In yet further aspects, the fallback rule may be to determine the PUCCH resource based on the PRI field of the last DCI indicating the first PUCCH or the last DCI indicating the second PUCCH received in a CORESET with a highest (or alternatively, lowest) starting CCE index relative to the other. For example, if the last DCI indicating the first PUCCH had a higher starting CCE index relative to the last DCI indicating the second PUCCH, and the predetermined rule was to select the highest starting CCE index, then the PUCCH resource would be selected based on the PRI of the last DCI indicating the first PUCCH.

At block 1435, the UE multiplexes the first and second sets of UCIs on the selected PUCCH resource. The UE may transmit those UCIs using the selected PUCCH resource as multiplexed.

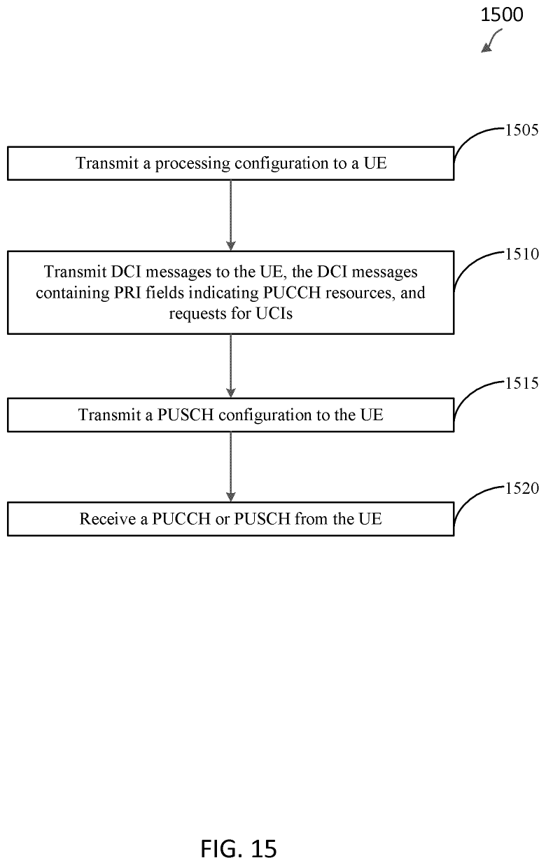

FIG. 15 is a flow diagram illustrating a wireless communication method 1500 according to some aspects of the present disclosure. Aspects of the method 1500 can be executed by a computing device (e.g., a processor, processing circuit, and/or other suitable component) of a wireless communication device or other suitable means for performing the blocks. In one aspect, a BS 105, a TRP, a CU 210 and/or DU 230, or network unit 1100, may perform the method 1500 utilizing components such as the processor 1102, the memory 1104, the UCI module 1108, the transceiver 1110, the modem 1112, and the one or more antennas 1116 shown in FIG. 11.

As illustrated, the method 1500 includes a number of enumerated blocks, but aspects of the method 1500 may include additional blocks before, after, and in between the enumerated blocks. In some aspects, one or more of the enumerated blocks may be omitted or performed in a different order.

At block 1505, a network unit transmits a processing configuration to a UE 115. The processing configuration may indicate, for example, whether to jointly or separately process UCIs of the same type.

At block 1510, the network unit transmits multiple DCI messages to the UE 115. The DCIs may have PRI fields associated with them indicating PUCCH resources. The DCIs may request UCIs from the UE 115 of different UCI types.

At block 1515, the network unit transmits a PUSCH configuration to the UE 115. The PUSCH configuration may be communicated dynamically (e.g., via DCI), or semi-statically (e.g., via configured grant). The PUSCH resource may overlap in time with one or more of the scheduled PUCCH resources.

At block 1520, the network unit receives a PUCCH or a PUSCH from the UE 115. The PUCCH or PUSCH may include all or a subset of the UCIs requested in the DCI messages.

Further aspects of the present disclosure include the following:

Aspect 1. A method of wireless communication performed by a user equipment (UE), the method comprising:
determining that a first physical uplink control channel (PUCCH) resource including a first set of uplink control informations (UCIs) associated with a first control resource set (CORESET) pool index value overlaps in a time domain with a second PUCCH resource including a second set of UCIs associated with a second CORESET pool index value;
receiving a scheduling configuration for a physical uplink shared channel (PUSCH) overlapping in time with at least one of the first PUCCH or the second PUCCH; and
multiplexing the first and second sets of UCIs on the PUSCH.
   Aspect 2. The method of aspect 1, the multiplexing further comprising:
concatenating a first UCI from the first set of UCIs with a second UCI from the second set of UCIs, in response to the first UCI and the second UCI being a same type, resulting in a concatenated UCI;
jointly encoding the concatenated UCI;
jointly rate matching the concatenated UCI; and
jointly mapping the concatenated UCI to the PUSCH,
wherein the concatenating the first UCI and the second UCI is based on an increasing order or decreasing order of the first CORESET pool index value and the second CORESET pool index value.
   Aspect 3. The method of aspect 1, the multiplexing further comprising:
separately encoding a first UCI from the first set of UCIs and a second UCI from the second set of UCIs, in response to the first UCI and the second UCI being a same type;
separately rate matching the first UCI and the second UCI; and
separately mapping the first UCI and second UCI to the PUSCH.
   Aspect 4. The method of aspect 3, the multiplexing further comprising:
dropping one or more UCIs from the first and second sets of UCIs after a first three UCIs from a priority order.
   Aspect 5. The method of aspect 4, wherein a highest priority UCI type of the priority order is HARQ-ACK.
   Aspect 6. The method of any of aspects 1-5, the multiplexing further comprising:
performing rate matching for a first hybrid automatic repeat request acknowledgement (HARQ-ACK) associated with the first CORESET pool index value by taking the first HARQ-ACK as HARQ-ACK;
performing rate matching for a second HARQ-ACK associated with the second CORESET pool index value by taking the second HARQ-ACK as a CSI part 1;
performing rate matching for a CSI part 1 by taking the CSI part 1 as a CSI part 2; and
dropping one or more UCIs from the first and second sets of UCIs after a first three UCIs from a priority order.
   Aspect 7. The method of aspect any of aspects 1-6, further comprising:
receiving a processing configuration for jointly processing or separately processing UCIs of a same type from the first and second sets of UCIs; and
performing encoding, rate matching, and mapping of the first and second sets of UCIs based on the processing configuration.
   Aspect 8. A method of wireless communication performed by a user equipment (UE), the method comprising:
determining that a first physical uplink control channel (PUCCH) resource including a first set of uplink control informations (UCIs) associated with a first control resource set (CORESET) pool index value overlaps in a time domain with a second PUCCH resource including a second set of UCIs associated with a second CORESET pool index value, wherein the first PUCCH resource is determined based on a PUCCH resource indicator (PRI) field in a first DCI, and the second PUCCH resource is determined based on a PRI field in a second DCI;
selecting a PUCCH resource set from a PUCCH resource pool based on a total number of bits in the first set of UCIs and the second set of UCIs;
selecting a PUCCH resource associated with the selected PUCCH resource set based on a predetermined rule; and
multiplexing the first set of UCIs and the second set of UCIs on the selected PUCCH resource.
   Aspect 9. The method of aspect 8, wherein the predetermined rule comprises selecting the PUCCH resource based on the PUCCH resource indicator (PRI) field in the first DCI or the second DCI associated with a predetermined CORESET Pool Index value.
   Aspect 10. The method of aspect 8, wherein the predetermined rule comprises selecting the PUCCH resource based on the PUCCH resource indicator (PRI) field of the first DCI or the second DCI with a highest or lowest value relative to the other.
   Aspect 11. The method of aspect 8, wherein the predetermined rule comprises selecting the PUCCH resource based on which of the first DCI or the second DCI is received in a later physical downlink control channel (PDCCH) monitoring occasion relative to the other.
   Aspect 12. The method of aspect 11, wherein the first DCI and the second DCI are received in a same PDCCH monitoring occasion, the method further comprising:
selecting the PUCCH resource based on a PUCCH resource indicator (PRI) field in the first DCI or the second DCI associated with a predetermined CORESET Pool Index value.
   Aspect 13. The method of aspect 11, wherein the first DCI and the second DCI are received in a same PDCCH monitoring occasion, the method further comprising:
selecting the PUCCH resource based on the PRI field of the first DCI or the second DCI with a highest or lowest PRI field value relative to the other.
   Aspect 14. The method of aspect 11, wherein the first DCI and the second DCI are received in a same PDCCH monitoring occasion, the method further comprising:
selecting the PUCCH resource based on the PRI field of the first DCI or the second DCI associated with a highest or lowest CORESET ID relative to the other.
   Aspect 15. The method of aspect 11, wherein the first DCI and the second DCI are received in a same PDCCH monitoring occasion, further comprising:
selecting the PUCCH resource based on a PUCCH resource indicator (PRI) field of the first DCI or the second DCI received in a CORESET with a highest or lowest starting CCE index relative to the other.
   Aspect 16. The method of aspect 8, further comprising:
receiving a control message indicating a first PUCCH resource pool associated with the first CORESET pool index value and a second PUCCH resource pool associated with the second CORESET pool index value; and
selecting the PUCCH resource pool based on the first PUCCH resource pool or the second PUCCH resource pool associated with a predetermined CORESET pool index value,
wherein the predetermined CORESET pool index value is one of a fixed value or a configurable value configured via a radio resource control (RRC) message.
   Aspect 17. The method of aspect 16, wherein the predetermined rule comprises selecting the PUCCH resource based on a PUCCH resource indicator (PRI) field of the first DCI or the second DCI associated with the predetermined CORESET pool index value.
   Aspect 18. A user equipment (UE) comprising:
a processor configured to:
   determine, that a first physical uplink control channel (PUCCH) resource including a first set of uplink control informations (UCIs) associated with a first control resource set (CORESET) pool index value overlaps in a time domain with a second PUCCH resource including a second set of UCIs associated with a second CORESET pool index value; and a transceiver configured to:
   receive a scheduling configuration for a physical uplink shared channel (PUSCH) overlapping in time with at least one of the first PUCCH or the second PUCCH; and
   multiplex the first and second sets of UCIs on the PUSCH.
      Aspect 19. The UE of aspect 18, wherein the transceiver is further configured to:
concatenate a first UCI from the first set of UCIs with a second UCI from the second set of UCIs, in response to the first UCI and the second UCI being a same type, resulting in a concatenated UCI;
jointly encode the concatenated UCI;
jointly rate match the concatenated UCI; and
jointly map the concatenated UCI to the PUSCH,
wherein the concatenating the first UCI and the second UCI is based on an increasing order or decreasing order of the first CORESET pool index value and the second CORESET pool index value.
   Aspect 20. The UE of aspect 18, wherein the transceiver is further configured to:
separately encode a first UCI from the first set of UCIs and a second UCI from the second set of UCIs, in response to the first UCI and the second UCI being a same type;
separately rate match the first UCI and the second UCI; and
separately map the first UCI and second UCI to the PUSCH.
   Aspect 21. The UE of any of aspects 18-20, wherein the transceiver is further configured to:
perform rate matching for a first hybrid automatic repeat request acknowledgement (HARQ-ACK) associated with the first CORESET pool index value by taking the first HARQ-ACK as HARQ-ACK;
perform rate matching for a second HARQ-ACK associated with the second CORESET pool index value by taking the second HARQ-ACK as a CSI part 1;
perform rate matching for a CSI part 1 by taking the CSI part 1 as a CSI part 2; and
drop one or more UCIs from the first and second sets of UCIs after a first three UCIs from a priority order.
   Aspect 22. The UE of any of aspects 18-21, wherein the transceiver is further configured to:
receive a processing configuration for jointly processing or separately processing UCIs of a same type from the first and second sets of UCIs; and
perform encoding, rate matching, and mapping of the first and second sets of UCIs based on the processing configuration.
   Aspect 23. A user equipment (UE), comprising:
a processor configured to:
   determine that a first physical uplink control channel (PUCCH) resource including a first set of uplink control informations (UCIs) associated with a first control resource set (CORESET) pool index value overlaps in a time domain with a second PUCCH resource including a second set of UCIs associated with a second CORESET pool index value, wherein the first PUCCH resource is determined based on a PUCCH resource indicator (PRI) field in a first DCI, and the second PUCCH resource is determined based on a PRI field in a second DCI;
   select a PUCCH resource set from a PUCCH resource pool based on a total number of bits in the first set of UCIs and the second set of UCIs; and
   select a PUCCH resource associated with the selected PUCCH resource set based on a predetermined rule; and a transceiver configured to:
   multiplex the first set of UCIs and the second set of UCIs on the selected PUCCH resource.
      Aspect 24. The UE of aspect 23, wherein the predetermined rule comprises selecting the PUCCH resource based on the PUCCH resource indicator (PRI) field in the first DCI or the second DCI associated with a predetermined CORESET Pool Index value.
      Aspect 25. The UE of aspect 23, wherein the predetermined rule comprises selecting the PUCCH resource based on the PUCCH resource indicator (PRI) field of the first DCI or the second DCI with a highest or lowest value relative to the other.
      Aspect 26. The UE of aspect 23, wherein the predetermined rule comprises selecting the PUCCH resource based on which of the first DCI or the second DCI is received in a later physical downlink control channel (PDCCH) monitoring occasion relative to the other.
      Aspect 27. The UE of aspect 26, wherein the first DCI and the second DCI are received in a same PDCCH monitoring occasion, wherein the processor is further configured to:
select the PUCCH resource based on a PUCCH resource indicator (PRI) field in the first DCI or the second DCI associated with a predetermined CORESET Pool Index value.
   Aspect 28. The UE of aspect 26, wherein the first DCI and the second DCI are received in a same PDCCH monitoring occasion, wherein the processor is further configured to:
select the PUCCH resource based on the PRI field of the first DCI or the second DCI with a highest or lowest PRI field value relative to the other.
   Aspect 29. The UE of aspect 26, wherein the first DCI and the second DCI are received in a same PDCCH monitoring occasion, wherein the processor is further configured to:
select the PUCCH resource based on the PRI field of the first DCI or the second DCI associated with a highest or lowest CORESET ID relative to the other.
   Aspect 30. The UE of aspect 26, wherein the first DCI and the second DCI are received in a same PDCCH monitoring occasion, wherein the processor is further configured to:
select the PUCCH resource based on a PUCCH resource indicator (PRI) field of the first DCI or the second DCI received in a CORESET with a highest or lowest starting CCE index relative to the other.
   Aspect 31. The UE of aspect 23, wherein the transceiver is further configured to receive a control message indicating a first PUCCH resource pool associated with the first CORESET pool index value and a second PUCCH resource pool associated with the second CORESET pool index value,
wherein the processor is further configured to select the PUCCH resource pool based on the first PUCCH resource pool or the second PUCCH resource pool associated with a predetermined CORESET pool index value, and
wherein the predetermined CORESET pool index value is one of a fixed value or a configurable value configured via a radio resource control (RRC) message.
   Aspect 32. The UE of aspect 31, wherein the predetermined rule comprises selecting the PUCCH resource based on a PUCCH resource indicator (PRI) field of the first DCI or the second DCI associated with the predetermined CORESET pool index value.
   Aspect 33. A user equipment (UE), comprising:
means for determining that a first physical uplink control channel (PUCCH) resource including a first set of uplink control informations (UCIs) associated with a first control resource set (CORESET) pool index value overlaps in a time domain with a second PUCCH resource including a second set of UCIs associated with a second CORESET pool index value;
means for receiving a scheduling configuration for a physical uplink shared channel (PUSCH) overlapping in time with at least one of the first PUCCH or the second PUCCH; and
means for multiplexing the first and second sets of UCIs on the PUSCH.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular aspects illustrated and described herein, as they are merely by way of some examples thereof, but rather, should be fully commensurate with that of the claims appended hereafter and their functional equivalents.

1. A method of wireless communication performed by a user equipment (UE), the method comprising:
determining that a first physical uplink control channel (PUCCH) resource including a first set of uplink control informations (UCIs) associated with a first control resource set (CORESET) pool index value overlaps in a time domain with a second PUCCH resource including a second set of UCIs associated with a second CORESET pool index value;
receiving a scheduling configuration for a physical uplink shared channel (PUSCH) overlapping in time with at least one of the first PUCCH or the second PUCCH; and
multiplexing the first and second sets of UCIs on the PUSCH.

2. The method of claim 1, the multiplexing further comprising:
concatenating a first UCI from the first set of UCIs with a second UCI from the second set of UCIs, in response to the first UCI and the second UCI being a same type, resulting in a concatenated UCI;
jointly encoding the concatenated UCI;
jointly rate matching the concatenated UCI; and
jointly mapping the concatenated UCI to the PUSCH,
wherein the concatenating the first UCI and the second UCI is based on an increasing order or decreasing order of the first CORESET pool index value and the second CORESET pool index value.

3. The method of claim 1, the multiplexing further comprising:
separately encoding a first UCI from the first set of UCIs and a second UCI from the second set of UCIs, in response to the first UCI and the second UCI being a same type;
separately rate matching the first UCI and the second UCI; and
separately mapping the first UCI and second UCI to the PUSCH.

4. The method of claim 3, the multiplexing further comprising:
dropping one or more UCIs from the first and second sets of UCIs after a first three UCIs from a priority order.

5. The method of claim 4, wherein a highest priority UCI type of the priority order is HARQ-ACK.

6. The method of claim 1, the multiplexing further comprising:
performing rate matching for a first hybrid automatic repeat request acknowledgement (HARQ-ACK) associated with the first CORESET pool index value by taking the first HARQ-ACK as HARQ-ACK;
performing rate matching for a second HARQ-ACK associated with the second CORESET pool index value by taking the second HARQ-ACK as a CSI part 1;
performing rate matching for a CSI part 1 by taking the CSI part 1 as a CSI part 2; and
dropping one or more UCIs from the first and second sets of UCIs after a first three UCIs from a priority order.

7. The method of claim 1, further comprising:
receiving a processing configuration for jointly processing or separately processing UCIs of a same type from the first and second sets of UCIs; and
performing encoding, rate matching, and mapping of the first and second sets of UCIs based on the processing configuration.

8. A method of wireless communication performed by a user equipment (UE), the method comprising:
determining that a first physical uplink control channel (PUCCH) resource including a first set of uplink control informations (UCIs) associated with a first control resource set (CORESET) pool index value overlaps in a time domain with a second PUCCH resource including a second set of UCIs associated with a second CORESET pool index value, wherein the first PUCCH resource is determined based on a PUCCH resource indicator (PRI) field in a first DCI, and the second PUCCH resource is determined based on a PRI field in a second DCI;
selecting a PUCCH resource set from a PUCCH resource pool based on a total number of bits in the first set of UCIs and the second set of UCIs;
selecting a PUCCH resource associated with the selected PUCCH resource set based on a predetermined rule; and
multiplexing the first set of UCIs and the second set of UCIs on the selected PUCCH resource.

9. The method of claim 8, wherein the predetermined rule comprises selecting the PUCCH resource based on the PUCCH resource indicator (PRI) field in the first DCI or the second DCI associated with a predetermined CORESET Pool Index value.

10. The method of claim 8, wherein the predetermined rule comprises selecting the PUCCH resource based on the PUCCH resource indicator (PRI) field of the first DCI or the second DCI with a highest or lowest value relative to the other.

11. The method of claim 8, wherein the predetermined rule comprises selecting the PUCCH resource based on which of the first DCI or the second DCI is received in a later physical downlink control channel (PDCCH) monitoring occasion relative to the other.

12. The method of claim 11, wherein the first DCI and the second DCI are received in a same PDCCH monitoring occasion, the method further comprising:
selecting the PUCCH resource based on a PUCCH resource indicator (PRI) field in the first DCI or the second DCI associated with a predetermined CORESET Pool Index value.

13. The method of claim 11, wherein the first DCI and the second DCI are received in a same PDCCH monitoring occasion, the method further comprising:
selecting the PUCCH resource based on the PRI field of the first DCI or the second DCI with a highest or lowest PRI field value relative to the other.

14. The method of claim 11, wherein the first DCI and the second DCI are received in a same PDCCH monitoring occasion, the method further comprising:
selecting the PUCCH resource based on the PRI field of the first DCI or the second DCI associated with a highest or lowest CORESET ID relative to the other.

15. The method of claim 11, wherein the first DCI and the second DCI are received in a same PDCCH monitoring occasion, further comprising:
selecting the PUCCH resource based on a PUCCH resource indicator (PRI) field of the first DCI or the second DCI received in a CORESET with a highest or lowest starting CCE index relative to the other.

16. The method of claim 8, further comprising:
receiving a control message indicating a first PUCCH resource pool associated with the first CORESET pool index value and a second PUCCH resource pool associated with the second CORESET pool index value; and
selecting the PUCCH resource pool based on the first PUCCH resource pool or the second PUCCH resource pool associated with a predetermined CORESET pool index value,
wherein the predetermined CORESET pool index value is one of a fixed value or a configurable value configured via a radio resource control (RRC) message.

17. The method of claim 16, wherein the predetermined rule comprises selecting the PUCCH resource based on a PUCCH resource indicator (PRI) field of the first DCI or the second DCI associated with the predetermined CORESET pool index value.

18. A user equipment (UE) comprising:
a processor configured to:
determine, that a first physical uplink control channel (PUCCH) resource including a first set of uplink control informations (UCIs) associated with a first control resource set (CORESET) pool index value overlaps in a time domain with a second PUCCH resource including a second set of UCIs associated with a second CORESET pool index value; and
a transceiver configured to:
receive a scheduling configuration for a physical uplink shared channel (PUSCH) overlapping in time with at least one of the first PUCCH or the second PUCCH; and
multiplex the first and second sets of UCIs on the PUSCH.

19. The UE of claim 18, wherein the transceiver is further configured to:
concatenate a first UCI from the first set of UCIs with a second UCI from the second set of UCIs, in response to the first UCI and the second UCI being a same type, resulting in a concatenated UCI;
jointly encode the concatenated UCI;
jointly rate match the concatenated UCI; and
jointly map the concatenated UCI to the PUSCH,
wherein the concatenating the first UCI and the second UCI is based on an increasing order or decreasing order of the first CORESET pool index value and the second CORESET pool index value.

20. The UE of claim 18, wherein the transceiver is further configured to:
separately encode a first UCI from the first set of UCIs and a second UCI from the second set of UCIs, in response to the first UCI and the second UCI being a same type;
separately rate match the first UCI and the second UCI; and
separately map the first UCI and second UCI to the PUSCH.

21. The UE of claim 20, wherein the transceiver is further configured to:
drop one or more UCIs from the first and second sets of UCIs after a first three UCIs from a priority order.

22. The UE of claim 21, wherein a highest priority UCI type of the priority order is HARQ-ACK.

23. The UE of claim 18, wherein the transceiver is further configured to:
perform rate matching for a first hybrid automatic repeat request acknowledgement (HARQ-ACK) associated with the first CORESET pool index value by taking the first HARQ-ACK as HARQ-ACK;
perform rate matching for a second HARQ-ACK associated with the second CORESET pool index value by taking the second HARQ-ACK as a CSI part 1;
perform rate matching for a CSI part 1 by taking the CSI part 1 as a CSI part 2; and
drop one or more UCIs from the first and second sets of UCIs after a first three UCIs from a priority order.

24. The UE of claim 18, wherein the transceiver is further configured to:
receive a processing configuration for jointly processing or separately processing UCIs of a same type from the first and second sets of UCIs; and
perform encoding, rate matching, and mapping of the first and second sets of UCIs based on the processing configuration.

25. A user equipment (UE), comprising:
means for determining that a first physical uplink control channel (PUCCH) resource including a first set of uplink control informations (UCIs) associated with a first control resource set (CORESET) pool index value overlaps in a time domain with a second PUCCH resource including a second set of UCIs associated with a second CORESET pool index value;
means for receiving a scheduling configuration for a physical uplink shared channel (PUSCH) overlapping in time with at least one of the first PUCCH or the second PUCCH; and
means for multiplexing the first and second sets of UCIs on the PUSCH.

26. The UE of claim 25, wherein the means for multiplexing further comprises:
means for concatenating a first UCI from the first set of UCIs with a second UCI from the second set of UCIs, in response to the first UCI and the second UCI being a same type, resulting in a concatenated UCI;
means for jointly encoding the concatenated UCI;
means for jointly rate matching the concatenated UCI; and
means for jointly mapping the concatenated UCI to the PUSCH,
wherein the concatenating the first UCI and the second UCI is based on an increasing order or decreasing order of the first CORESET pool index value and the second CORESET pool index value.

27. The UE of claim 25, wherein the means for multiplexing further comprises:
means for separately encoding a first UCI from the first set of UCIs and a second UCI from the second set of UCIs, in response to the first UCI and the second UCI being a same type;
means for separately rate matching the first UCI and the second UCI; and
means for separately mapping the first UCI and second UCI to the PUSCH.

28. The UE of claim 20, wherein the means for multiplexing further comprises:
means for dropping one or more UCIs from the first and second sets of UCIs after a first three UCIs from a priority order.

29. The UE of claim 25, wherein the means for multiplexing further comprises:
means for performing rate matching for a first hybrid automatic repeat request acknowledgement (HARQ-ACK) associated with the first CORESET pool index value by taking the first HARQ-ACK as HARQ-ACK;
means for performing rate matching for a second HARQ-ACK associated with the second CORESET pool index value by taking the second HARQ-ACK as a CSI part 1;
means for performing rate matching for a CSI part 1 by taking the CSI part 1 as a CSI part 2; and
means for dropping one or more UCIs from the first and second sets of UCIs after a first three UCIs from a priority order.

30. The UE of claim 25, further comprising:
means for receiving a processing configuration for jointly processing or separately processing UCIs of a same type from the first and second sets of UCIs; and
means for performing encoding, rate matching, and mapping of the first and second sets of UCIs based on the processing configuration.
